(19) United States
(12) Patent Application Publication
(10) Pub. No.: US 2022/0027380 A1
(43) Pub. Date: Jan. 27, 2022

(54) DATA MANAGEMENT SYSTEM AND METHOD FOR GENERAL LEDGER

(71) Applicant: Berkley Insurance Company, Greenwich, CT (US)

(72) Inventors: Jamie L. Martin, Urbandale, IA (US); Ryan Beck, Windsor Heights, IA (US)

(73) Assignee: Berkley Insurance Company, Greenwich, CT (US)

(21) Appl. No.: 17/381,814

(22) Filed: Jul. 21, 2021

Related U.S. Application Data
(60) Provisional application No. 63/054,484, filed on Jul. 21, 2020.

(51) Int. Cl. G06F 16/25; G06F 16/23; G06F 16/28; G06Q 40/08; G06F 21/62

(52) U.S. Cl. CPC G06F 16/254; G06F 16/2358; G06F 2221/2141; G06Q 40/08; G06F 21/6245; G06F 16/283

(57) ABSTRACT

A method of processing and harmonizing raw data to generate reports is disclosed herein. The method includes collecting raw data from a plurality of users including a plurality of different file types. The method includes staging the raw data by analyzing the raw data based on data quality rules and data governance protocols and harmonizing the raw data from the plurality of users. The method includes calculating a plurality of insurance related parameters based on the raw data. The method also includes generating a plurality of journal entries based on the plurality of insurance related parameters. The method can then include approving at least one journal entry of the plurality of journal entries via an approval interface, or denying at least one journal entry of the plurality of journal entries based on detection of an error in the at least one journal entry.

### CROSS REFERENCE TO RELATED APPLICATION

This application claims priority to U.S. Provisional Patent Application No. 63/054,484, filed Jul. 21, 2020, the disclosure of which is hereby incorporated by reference as if set forth in its entirety herein.

### FIELD OF INVENTION

This application relates to data management. Specifically, this application relates to data management in the insurance industry.

### BACKGROUND

With the increasing ability to store, process, and analyze large amounts of data, service providers, such as insurance or financial entities, have increasing access to large amounts of data. However, there is a growing issue with the ability to process this data, particularly when the data is generated from a variety of disparate origins, such as and without limitation, legacy policy administration systems, claim management systems, stand-alone data warehouses and third-party data exchanges.

Due to the large volume of legacy systems and distributed data, there are challenges associated with consolidation and analysis of financial data. In order to address these challenges, many entities rely on manual human intervention which is time consuming, expensive, and labor intensive. Additionally, human intervention introduces the possibility for mistakes or inadvertent approval of key documents, reports, or data.

Accordingly, there is a growing need for advanced digital transformation and data analytics to increase efficiency and improve process automation. These improvements would help reduce cycle time across various functional processes internally and create an opportunity to automate or industrialize digital capabilities and would create commercial competitive advantages.

### SUMMARY

The systems and methods disclosed herein are directed to utilizing advanced analytical techniques to extract, analyze and collate raw data from various sources and across multiple customers, businesses, or users. The systems and methods transform data into meaningful financial information at the enterprise level. The systems and methods are configured to extract gross data, such as premiums, claims, etc., from various distributed source systems.

In one aspect, the system and methods disclosed herein are intended to harmonize and conform data across various entities and sources to then be used to optimize and automate business processes, e.g. financial close and enhanced data analytics. The configurations disclosed herein can automatically apply industry specific data rules and algorithms through the utilization of metadata and crosswalks to standardize and normalize the data and generate industry specific analysis and generate financial calculations to automate business processes.

For example, in one aspect, the analytical techniques include checking data from clients or tenants using various data modeling processes or formulas. In one aspect, the analytical techniques include checking data against quality rules, business rules, and enriching data. In one aspect, the analytical techniques also synchronize or harmonize data from multiple users or tenants. Transforming this data from the clients can also include data scrubbing and mapping techniques.

Data rules can be defined to support business functions and data quality. These are checked and then presented in a graphical output (i.e. a data governance dashboard). Some examples of data rules can include checking if a transaction duration should not be longer than twenty years, checking that the timestamp for a certain transaction is not in the future and therefore erroneous, that all closed dates are on or after an open date, that written premium amounts each have a specific assigned territory or territory code, formatting issues for contract numbers or claim numbers, ensuring all required data fields are populated, etc. One of ordinary skill in the art would understand that these are examples and many other data rules can be configured to be checked by the systems and methods disclosed herein.

Extracting gross data from clients or tenants can include a data sourcing step, which is described in more detail herein. This extracting step can include connecting to the source system(s), transferring appropriate data elements from the source system(s) to the staging data and performing data compressions. Data compression can include summarizing unnecessary transactional data into a single representative transaction.

Transforming the data can include identifying changes in source system data using incremental detection (e.g., changes since the last time data was extracted), change data capture (CDC) (e.g., changes which are logged on the source system), and change data detection (CDD) (e.g., comparison of current source system values to previous source system values to generate change). The above methods are then applied to map source system changes into a conformed data model.

The systems and methods are configured to apply pre-programmed business rules and calculations to the gross data, and then perform ceded/reinsurance calculations to generate net financial analysis before interfacing the data automatically to the organization's general ledger system. The system conforms source system values into standardized values allowing the standardized values to be combined in various combinations to create consistent business rules. For example, the system takes raw source system values from each tenant identifying direct/assumed business, contract type code and transaction type and maps the values to standardized values. The standardized values are then mapped to general ledger (GL) accounts to route location in the financial statements in the GL. The systems and methods also provide a unique multi-purpose solution that simultaneously combines the functionality of data analytics and workflow automation.

In one embodiment, a system for collecting, organizing, analyzing and displaying information is provided. The system includes a receiver module configured to receive data input from a plurality of sources. A quality module is configured to evaluate data received by the receiver module and generate staged data. A visualization module is configured to display the staged data. A reference module is configured to automatically map staged data to a particular mapping element. A calculation module is configured to generate insurance parameters based on the staged data. A journal entry module is configured to populate a general ledger based at least on the staged data and the insurance parameters.

In one embodiment, a reference data mapping suggestion module is configured to automatically map user data to specific insurance parameters. In one embodiment, an event driven scheduling module is configured to create customized reports using trigger points from a data governance module.

A reference data discovery module can be configured to generate experience-based parameters and to identify new reference data, such that the reference data discovery module automatically triggers loading new reference data and notifications to a user. Experience-based, as used in this context, means the automatic collection profiling of data configurations which have been used in the system versus all combinations which are potentially available. A reinsurance module can be configured to calculate reinsurance elements in another embodiment.

In one embodiment, a foreign exchange translation module is configured to generate currency conversions. In one aspect, the system is configured to calculate foreign exchange currency conversions, and then generate data based on these conversions. The exchange currency conversions can be used for at least two distinct purposes. First, the conversions can be used to convert transacted amounts into currencies necessary to facilitate the regulatory need for a legal entity. Second, the conversions can be used to conform all transacted amounts to a common currency to allow consistent analysis across the system. The systems can be configured to perform up to five currency translations based upon a currency profile associated with a legal entity.

A multi-dimensional security module can be configured to assign security features to information within the system. A directed analytics module can be configured to analyze and process data in the system to provide exception-based workflow. In another aspect, a configuration module can be configured to automate application initialization across multiple modules in the system.

A method of collecting, organizing, analyzing and generating information is also disclosed. This method can be used to ultimately generate data, reports, and other information that is then used to tailor evolving needs of clients or tenants. For example, the method can be used to generate consolidated data reports that are stored in a centralized manner. The method can include capturing disparate data from a plurality of tenants and users and then standardizing or centralizing the data such that data is harmonized according to multiple insurance related reporting requirements and calculations. The method can include integrating this harmonized data into business intelligence reporting programs or interfaces which allows users or tenants to have a clearer understanding of the data. Based on this information, the method provides an improved approach for better understanding a client's evolving needs, based on loss trends and business data, thereby allowing for a tailored approach.

In one aspect, the method includes: (a) collecting raw data from a plurality of users; (b) staging the raw data by analyzing the raw data based on data quality rules and data governance protocols; (c) enriching the raw data and calculating a plurality of insurance related parameters based on the raw data; and (d) generating journal entries based on the plurality of insurance related parameters.

The method can also include processing the enriched raw data after step (c) to calculate ceded data. In another embodiment, the method includes providing a dashboard interface configured to display the raw data, the plurality of insurance related parameters, and the journal entries. Using the dashboard interface, a user can take further actions, such as approving or denying specific aspects of the data or reports, viewing audit trails, running data quality rules, and other actions. Usage of the dashboard interface provides support and automation for business processes, such as month-end tasks. This can include a workflow trigger operation that involves data review. In one aspect, the dashboard is configured to pull all data which is required for the user to approve or adjust the data. This information would include any data quality rules violated, any new mappings that need to be provided and control totals from the latest load to perform balancing. The audit trail behind the dashboard reflects, for example, the timestamp and the name of the person who interacted with the dashboard, e.g. who approved the data and when. Other information can be included in the audit trail, such as monetary information.

In one embodiment, the plurality of insurance related parameters at least includes: risk data, earnings data, loss data, and commission data. The method can further require approval from at least two users before step (d).

In another embodiment, step (b) further includes reviewing the raw data based on data governance rules and data quality rules. The raw data from the plurality of users includes different file types and different naming conventions.

Step (b) can further include mapping the different file types and different naming conventions to a single common set of file types and naming conventions. The raw data from the plurality of users includes all of the following: claim data, coverage data, contract data, risk data, term data, loss data, premium data, receivables data, and submissions data.

In one embodiment, the method also includes generating foreign currency exchange rates during step (d). The method can further include assigning a security protocol to the information generated during step (d). Step (b) can further include providing a user interface in which a user is required to validate the raw data in another embodiment. Step (c) can further include processing the raw data through a reference data discovery module which is configured to identify new reference data and trigger loading of new reference data based on the raw data. In one embodiment, the method also includes creating an audit trail between steps (a)-(d).

In one aspect, the system automates the extraction of data from multiple tenants, conforms the data using consistent values while standardizing the calculations allowing an enterprise view of the data without hundreds of disparate automated/manual processes with inconsistent application of business rules.

A method of generating journal entries for review by a user is also disclosed herein. The method includes collecting raw data from a plurality of users including a plurality of different file types. The method includes staging the raw data by analyzing the raw data based on data quality rules and data governance protocols and harmonizing the raw data from the plurality of users. The method includes calculating a plurality of insurance related parameters based on the raw data. The method also includes generating a plurality of journal entries based on the plurality of insurance related parameters. The method can then include approving at least one journal entry of the plurality of journal entries via an approval interface, or denying at least one journal entry of the plurality of journal entries based on detection of an error in the at least one journal entry.

Additional embodiments, variations and aspects are disclosed herein.

### BRIEF DESCRIPTION OF THE DRAWINGS

The foregoing Summary and the following Detailed Description will be better understood when read in conjunction with the appended drawings, which illustrate a preferred embodiment of the invention. In the drawings:

FIG. 1 illustrates a schematic illustration of a data system according to one embodiment.

FIG. 2 illustrates a flow diagram of a data management process according to one embodiment.

FIG. 3A illustrates an exemplary device for implementing the data system of FIG. 1 and/or the flow diagram of FIG. 2.

FIG. 3B illustrates an exemplary arrangement for connecting a device to the data system.

FIG. 4 illustrates a screenshot of an interface, such as XLPro, according to one embodiment.

FIGS. 5A-5C illustrate exemplary interfaces of different aspects of a Mapping Automation Tool (MAT) module.

FIG. 6 illustrates an exemplary interface of one aspect of a Data Acquisition Automation (DAA) module.

FIG. 7 illustrates an interface with Tidal according to one embodiment.

FIG. 8 illustrates an embodiment of a data governance dashboard.

FIG. 9 illustrates an embodiment of a Configuration Engine module.

FIGS. 10A and 10B illustrate aspects of a Data Entry Automation module.

FIG. 10C illustrates one embodiment of a data entry interface.

FIG. 11 illustrates a data governance dashboard according to one embodiment.

FIG. 12A illustrates one embodiment for a company landing page interface.

FIG. 12B illustrates one embodiment for a balancing interface or module in OBIEE/PeopleSoft.

FIG. 12C illustrates a landing page for PeopleSoft.

FIG. 12D illustrates an embodiment of an approval interface.

FIG. 12E illustrates an embodiment for an OBIEE dashboard.

FIG. 13 illustrates one example of a method for collecting, organizing, analyzing and displaying information.

FIG. 14 illustrates one example of a system for collecting, organizing, analyzing and displaying information.

### DETAILED DESCRIPTION OF PREFERRED EMBODIMENTS

The present systems, apparatus, and methods are configured to collect, manage, analyze, and display information from a variety of sources, such as companies or tenants, among a variety of different types of information.

Generally, the systems, methods, and protocols disclosed herein create a centralized data pipeline in which data can be extracted automatically from numerous discrete sources. This enables users to convert data into meaningful financial information with minimal manual intervention.

In one embodiment, the system is configured to capture fields or data from any or all of the following categories: claims, coverages, contracts, risk, terms, loss, premium, receivables, and submissions. One of ordinary skill in the art would understand based on this disclosure that other categories or dimensions can be implemented in the present system.

In one aspect, the system is directed to utilizing cross mapping, data rules and select inputs to facilitate the creation and maintenance of a sub-ledger allowing for operational reporting and the creation of journal entries and key performance indicators. In one aspect, the system is intended to harmonize and conform data across various entities and sources to be then used to optimize and automate business processes e.g. financial close and enhanced data analytics. The system applies industry specific data rules and algorithms through the utilization of metadata and crosswalks to standardize and normalize the data and generate industry specific analysis and generate financial calculations to automate business processes. A crosswalk, in one aspect, is defined as a mapping of a one-way relationship of code value and a code list.

As used in this disclosure, the term claims can include attributes associated with a claim against a contract, such as an insurance or financial contract. In one embodiment, the claims include attributes associated with both the claim and any claimants associated with the claim. Attributes of a claim can include dates associated with the claim, such as the claim opening date, closing date, loss date, and report date. Claimant attributes can include the claimant's name or the claimant's address, as well as other identifying characteristics of the claimant. Other attributes of the claim can include the type of loss and catastrophe code.

The term coverages as used herein refers to attributes associated with insurance coverage for an insurance contract. The data associated with coverages includes the coverage code, annual statement line of business, and other associated attributes. Premium and loss transactions are also linked to these coverages. One of ordinary skill in the art would understand that other related data can be associated with the coverage data.

In an embodiment, the term “contract” is used herein as a generalized term for an insurance or financial contract. One of ordinary skill in the art would understand that other contracts are encompassed within the scope of this disclosure. In one embodiment, the term contract refers to primary insurance contracts, reinsurance treaties, and facultative certificates. The contract data can also include descriptive information on insureds and producers (e.g. agents and brokers) as well as the contract level attributes. Premium and loss transactions can also be linked to the contracts in one embodiment.

The term risk includes attributes associated with risks covered by a contract, such as a specific insurance contract. These attributes can generally describe the location of the risk, such as the geographical position, address, longitude/latitude, etc. Other characteristics regarding the construction of the risk can also be considered.

Regarding terms, this word is an abbreviation for the phrase policy terms and conditions. The terms are specific to each contract and specify the characteristics of coverage for each contract. In one embodiment, the terms can specify limits, deductibles, participation percentages, and coverage endorsements and exclusions.

The system also considers losses, which typically includes loss transactions associated with a claim, such as an insurance claim. The transactions can include payments and reserve changes, as well as categorizations as to whether a transaction is for indemnity, medical, adjusting and other (A&O) expenses or DCC expenses (e.g., litigation, defense, and medical cost containment). Other loss attributes can include payment details such as the date, check or reference number, and details about the payee.

Regarding the term premium, as used herein this term refers to premium transactions associated with a contract. The premium transactions can contain premium, commission, and surcharge details. Underlying rating elements can also be included in the premium transactions. These premium transactions are linked to an associated contract, coverage, and risk attributes.

The term receivables includes information regarding premium receivables and cash collection. In one embodiment, the receivables include information regarding application of cash, customer account reconciliation, and banking reconciliation.

The term submissions refers to basic information on a submitted proposal of insurance to an underwriter. In one embodiment, the submissions contain insured information, information on quotes offered, whether the business was bound, and the reasons why a business may have not been bound.

The present system is configured to implement XLPro as an outward/ceded reinsurance solution, including standardization and centralization of reinsurance treaties and facultative contracts management and reporting, as well as ceded billing calculations.

In one aspect, XLPro refers to any analysis or visualization interface or software implemented program. In one aspect, XLPro is a software program offered by DXC that is configured to support reinsurance business processes, calculation, and report functions. While the term XLPro is used in this disclosure as one example of a reinsurance software program, one of ordinary skill in the art would understand that other types of visualization and analysis interfaces could be used that are similarly configured to be integrated to provide an end-to-end solution.

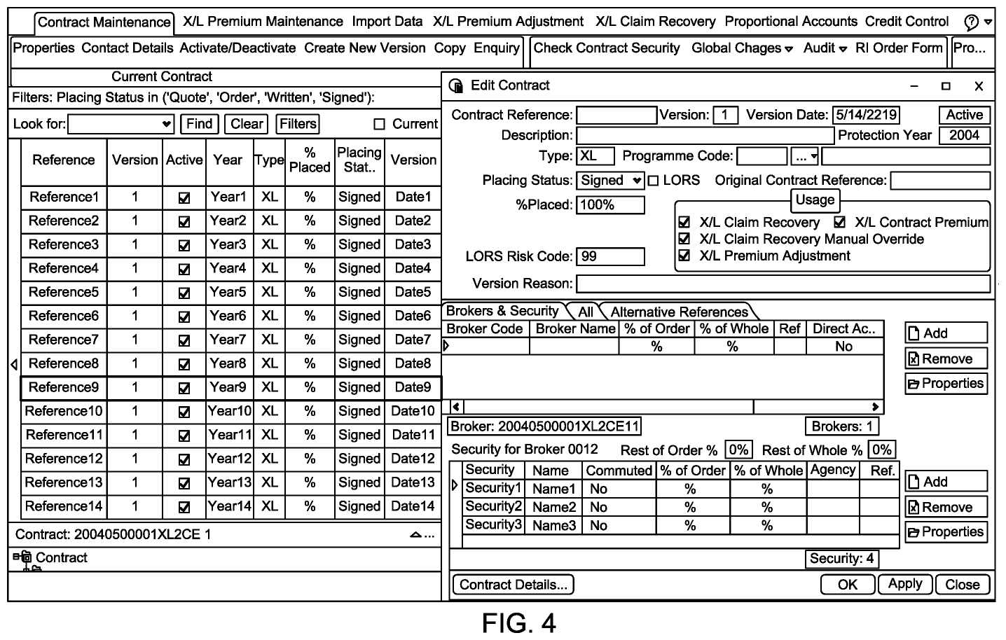

In one embodiment, XLPro fully automates reinsurance calculations for recoveries and costs, as well as providing the required documentation and credit control functionality. With its calculation engine and configurability, XLPro manages the entire outwards reinsurance process with a high degree of automation. The present disclosure provides a system and method that enables the calculation of reinsurance, such as ceded cessions for ceded written premiums, ceded earned premiums, ceded commissions, etc. XLPro is configured to be integrated into third party systems and to improve straight-through processing for reinsurance business. In one embodiment, XLPro can be configured to use different calculation rules for a contract, for example through the use of clauses, which mirror the clauses included in the contract wording. FIG. 4 illustrates a screenshot of XLPro according to one embodiment. As shown in FIG. 4, various aspects of a particular contract can be modified. As shown in FIG. 4, a user of the system can edit various elements of a specific contract. A user can analyze references based on various parameters, such as the year, status (i.e. active), and other information. In one aspect, a user can view a risk code associated with a specific contract. Additional details regarding the collateral of a particular contract are also viewable in this interface. XLPro interfaces with the system and methods in a very consistent manner enabled by the data governance which allows users to fully aggregate the ceded risk across the whole enterprise.

The system also automates general ledger journal entries. The system is configured to utilize the MAT and the data quality rules to create a series of rules that will validate whether or not there is an existence for chart fields which require internal or external reporting as it comes from the data warehouse. The MAT function allows the finance personnel, who is at least one primary consumer of the journal entries, the ability to adjust chart field requirements as needed without the intervention of technology personnel. A foundation is established by the system for future reporting capabilities by utilizing various business intelligence tools.

As used in this disclosure, the term journal entries include any type of data or information that is ultimately used in the general ledger. The journal entries can include records of transactions for multiple users or tenants of the system. As used herein, the term general ledger refers to a complete record or accounting of all journal entries associated with a particular user, matter, or other entity. The journal entry, in one aspect, is used to record transactions in the accounting records. The journal entry is recorded in the general ledger. The general ledger is then used to create financial statements.

The system also implements and oversees corporate data governance. As used herein, the term data governance refers to the stewardship and ownership of application of business and technology rules and regulations. Data governance is configured to identify issues with data sets and remediate these issues.

In one example, corporate data governance can include an iterative or repetitive cycle consisting of three main components: policies, process, and compliance. The policies component can comprise referring to relevant policies, rules, and terms, such as an information governance catalog and reference data management. This process can also include a data dictionary aspect. The process component can include both data submission and data profiling. Data submission can include obtaining source data from a source system or staging environment. The data profiling component can include applying data quality rules to data obtained by a company, tenant, or client. This aspect can include an information governance dashboard, hundreds of data quality rules, and a plurality of policies and severities. Finally, the compliance component can include value mapping, remediation, and approval. During value mapping, the reference data management aspect can ensure there are consistent values and check the compliance or fit between source data and target values. During remediation, any corrective or remedial action can be handled. This can include examining ETL, data entry, business processes, system capability, warehouse capability, and rule fit or application. Finally, the approval component can be carried out after proper remediation. This aspect confirms that there is a trusted data source, checks the information assets, and the business values.

Data governance is generally described herein. In one aspect, data governance is configured to identify any data quality issues and locate the issues; alert or inform any users of the system (i.e. data stewards) of how much data is loaded and of any issues with the data; and also to provide an approval interface for the users.

In one aspect, data quality error detection can be carried out by the system and method disclosed herein. Some examples of data quality errors that can be detected include: quality check errors, balancing errors, and reference data management (RDM) mapping errors. Quality check errors can occur for issues, such as failure of a client to populate a required field of data input. Other quality check errors can arise. Balancing errors can occur, for example, when data from a client does not balance or match data sent to the data warehouse staging. RDM mapping errors can occur when a client inputs data that does not align to the value stored at a corporate or higher level.

Data quality rules can be assigned a designated or severity level by the system. These ratings can then be used by the system or method, and can apply greater weights to rules with higher severity. Some exemplary severity levels can include fatal, critical, or quality. One of ordinary skill in the art would understand that these ratings can vary and include fewer or more than three ratings. Fatal severity rules can be the highest level and therefore highest weight, and can be configured to ensure balancing, integrity of the warehouse, proper population of fields and data, proper mapping of data, as well as any other crucial relationships or dependencies amount data or fields. Critical severity or quality severity rated items can be configured to be less important items and therefore less weight, such as population, mapping, and dependency aspects of the data or fields. In one aspect, each piece of data or information from a client is assigned a classification that is configured to determine its impact on data report generation.

In one aspect, fatal issues can include required data for reporting, such as Solvency II, GAAP, NAIC, or related information etc. This information can be mandatory for processing. In one aspect, critical issues can be required for internal reporting and may include legal, reinsurance processing data, producer data, etc. Critical information is commonly supplied by companies or clients for internal reporting processing. Critical data may include fields that are useful but not mandatory for processing. Quality type information may include information requested for reporting, including producer, legal, and reinsurance processing data. This type of information is commonly unavailable within a company's source systems.

The system disclosed herein can support the Association of Cooperative Operations Research & Development P&C XML (ACORD) model as an interface in one embodiment. In other embodiments, the ACORD model can be used as an input, which would allow systems that support the native ACORD industry model to be easily integrated with the present system.

In one embodiment, the system disclosed herein includes the following components:

Mapping Automation Tool (MAT). In one aspect, the MAT generally is configured to receive an input of source system metadata, data and profiling results and profiling results, and is configured to output a source for target mapping metadata. For example, the system can be configured to extract the data base catalogue of a source system and run data profiling algorithms to identify sources for target pairings. Examples of such algorithms include prior analysis of previously implemented systems and natural language processing, among many others.

Data Acquisition Automation (DAA). In one aspect, the DAA is configured to receive an input of source to target mapping metadata, and output generated ETL processes for use to acquire data from source systems. This component can be configured to take the source to target metadata results from the MAT and convert this information into tool specific schemas, such as SQL Server Integration Services Package.

Data Quality Automation and Remediation module (DQA+R). In one aspect, the DQA+R is configured to receive an input of data quality violation (e.g. accounting date needs to be the last day of the month), and outputs automated data remediations using pattern detection. For example, a data quality rule can check for any accounting dates which are not the end of the month and would flag the violation. A remediation component of the DQA+R can be configured to detect this violation and perform automated remediation to update the accounting date to the last day of the month. The process would then re-execute until all remediations are resolved. This process can be carried out in an iterative manner.

Workflow Engine (WE) (e.g. Dashboard/PeopleSoft Approval/Tidal). In one aspect, the WE is configured to receive an input of approvals and is then configured to output commencement of the event driven scheduling model (EDS). For example, in one aspect, a user clicks the approval button which generates an approval event to be picked up by the EDS module.

Event Driven Scheduling module (EDS) (e.g. Tidal). In one aspect, the EDS is configured to receive an input of events generated by the WE, and is configured to output instantiation of Tidal processes. For example, an approval event is received and the post approval jobs and parameters are dynamically inserted into the schedule.

Reference Data Discover module (RDD). In one aspect, the RDD is configured to receive an input of database metadata, and output a distinct list of values which do not exist in the reference data management (RDM) tool. For example, the data steward would list the data base columns of the field to be codified and the RDD is configured to dynamically generate the SQL to extract distinct values which do not exist in the RDM tool and would automatically add the new values to the RDM tool.

Reference Data Mapping Suggestion Engine (RDMSE). In one aspect, the RDMSE generally is configured to receive an input of source system values, and output mapping recommendations to conformed values based upon prior experience or algorithms, such as natural language processing to identify a mapping accuracy score. The process will evaluate any reference data values which have not been previously conformed and will compare those to values which have been previously conformed. The various libraries will then use the previously conformed values to produce recommendations for the unconfirmed values. For example: a state abbreviation received from a source system can be checked and evaluated against previous state abbreviations from other tenants, and therefore the RDMSE can be configured to produce a mapping recommendation and similarity score. One of ordinary skill in the art would understand that this concept is simplified for exemplary purposes only, and more sophisticated data points can be checked and mapped.

Calculation Engine (Calc Engine or CE). In one aspect, the CE is configured to receive an input of conformed transactional metadata, and output various property and casualty (P&C) insurance specific financial calculations and key performance indicators (KPIs). For example, in one aspect, the following data can be received from the source or source system: written premium amount, the tenant key, the legal entity, a premium transaction type, a calculation earning method, transaction effective dates and transaction expiration date. At least the premium transaction type, calculation earning method, tenant key, and legal entity would be conformed (i.e. modified, adjusted, etc.) by the MAT and utilized by the CE to generate earned and unearned premium calculations consistent with revenue recognition. In one aspect, revenue recognition is a generally accepted accounting principle (GAAP) that identifies the specific conditions in which revenue is recognized and determines how to account for it. Typically, revenue is recognized when a critical event has occurred, and the dollar amount is easily measurable to the company.

Reinsurance Engine (RE) (e.g. XLPro). In one aspect, the RE is configured to receive an input of conformed financial facts derived from upstream processes, and output raw ceded financial transactions which is then treated as a separate tenant.

Journal Entry Automation (JEA) module (e.g. general ledger (GL) Interface). In one aspect, the JEA is configured to receive an input of financial calculation generated by the CE and mapped to GL accounts, and output at least one XML file containing journal lines which can be automatically imported into the enterprise general ledger.

Configuration Engine (RPA/AI/ML). As used in this context, RPA means robotic process automation, AI means artificial intelligence, and ML means machine learning. In one aspect, the Configuration Engine is configured to receive an input of reinsurance treaty and facultative certificate metadata, and is configured to output XLPro contract configurations using the XLPro user interface. One of ordinary skill in the art would understand that other programs besides XLPro may be used. In one example, the system collects reinsurance treaty and facultative certificate metadata and data from the source reinsurance system, and then maps the data to a canonical model. The data elements within the canonical model are mapped to specific fields on specific XLPro Screens and the Configuration Engine enters the information into XLPro without requiring human intervention.

Data Entry Automation module (RPA/AI/ML). In one aspect, the Data Entry Automation module is configured to receive an input of historical facultative legacy system metadata, and is configured to output a validated facultative certificate in XLPro (Reinsurance solution/module). As an example, the module can use robotic process automation (RPA) to enter a facultative certificate based on defined data points in an automated way with a translation from old to new system, as compared to requiring manual set-up.

Foreign Exchange Translation module (FET). In one aspect, the FET is configured to receive an input of financial calculations and KPIs from the CE along with a currency profile for a legal entity and currency translation rates, and is configured to output financial calculations and KPIs translated to the target currency rates at the point in time of multiple currency types to facilitate local and statutory reporting. In one aspect, the FET is configured to translate these rates into at least five different currency types, such as consolidated/USD, domicile, functional, source, and reporting currency type.

Directed Analytics module (DA) (e.g. OBIEE/Essbase/PowerBI/Cognos). In one aspect, the DA is configured to receive an input of user selection criteria, and is configured to generate reports and analytics that drill into the general ledger data in more detail. In one example, the DA provides the ability or interface to review a plurality of written premiums by contract level.

Multi-dimensional row level security (MDRLS). In one aspect, the MDRLS is configured to receive an input of conformed values and utilizes multiple hierarchies. The MDRLS is then configured to output row level security. For example, the data steward can create multiple hierarchy roll-ups which can be applied to the data to allow users to see various roll-ups as defined by the hierarchies. One hierarchy could be by legal entity, while another might be by corporate profit center, or the combination of both.

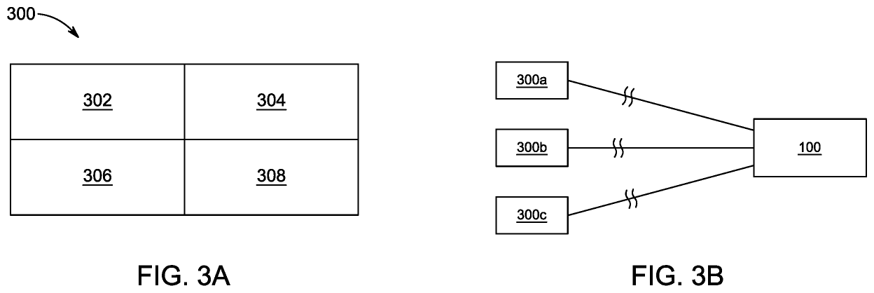

Each of these components can be implemented as modules or sub-components within the system. In one embodiment, any one or more of these components are implemented with a device 300 in FIG. 3A, which is described in more detail herein. In one aspect, the modules can be implemented as software executable programs.

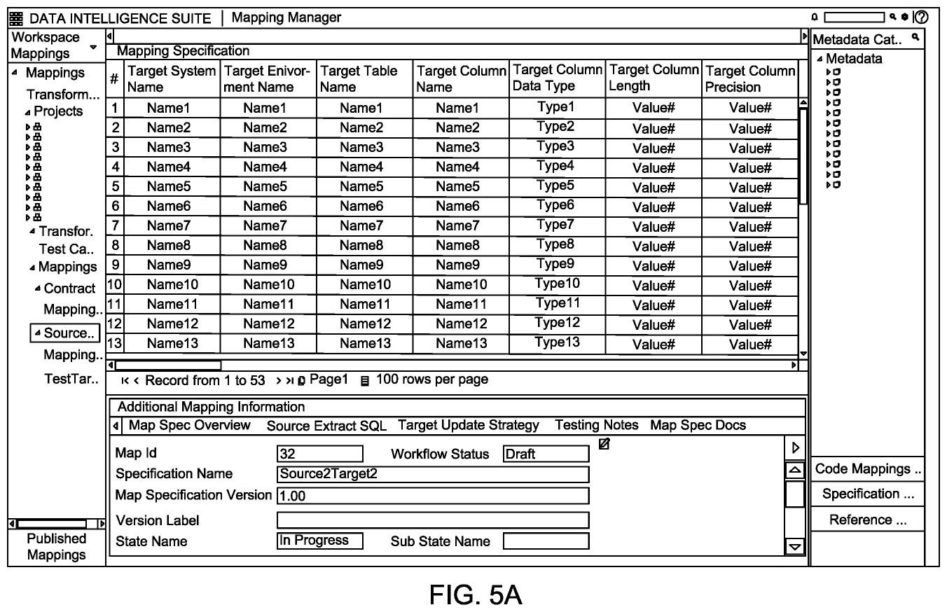

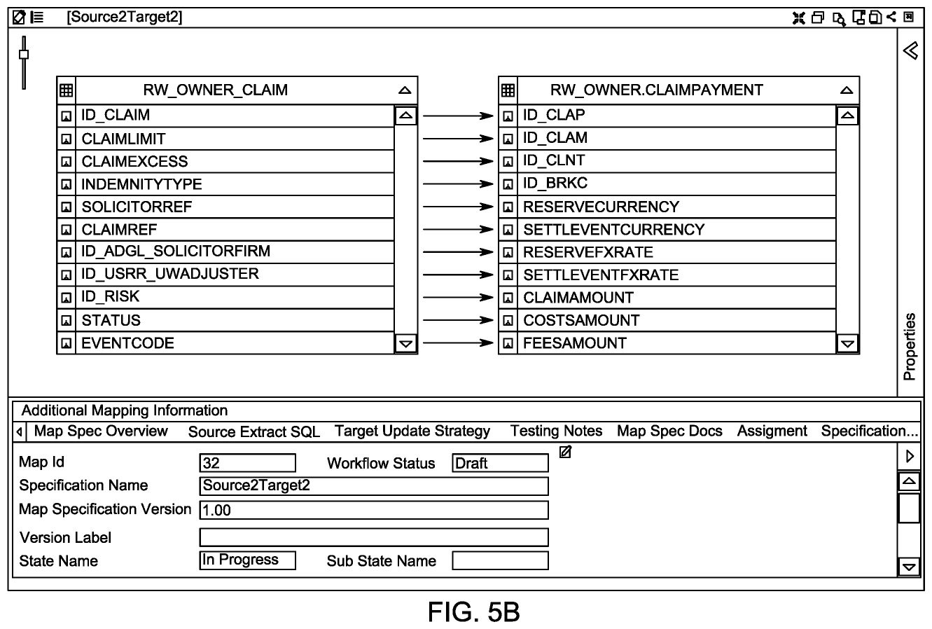

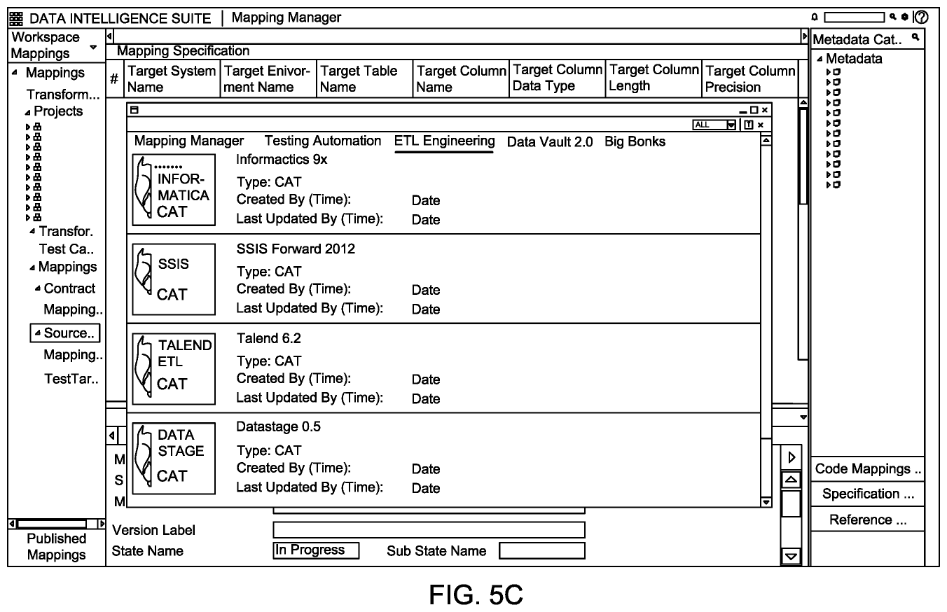

The MAT is configured to provide a GUI interface which allows business users to drag and drop selected metadata from the source and creates the association for the DAA. The MAT is also referred to as a data receiver module or a receiver module herein. FIGS. 5A-5C illustrate exemplary interfaces for using the MAT. As shown in FIGS. 5A-5C, a mapping manager is provided that is configured to analyze multiple targets, clients, tenants, or other data. Using this interface, a user can analyze various data mapping parameters regarding claims and other insurance-based data and determine a target column length and target column precision. In one aspect, the system is configured to match columns in the source database to the columns in the target database to generate the ETL (as shown in FIG. 5B). FIG. 5B illustrates mapping between an owner claim and claim payment. As shown in this Figure, mapping is carried out between various insurance related data. FIG. 5C illustrates how ETL engineering processes can be performed on the data. In one aspect, the configuration shown in FIG. 5C allows for further customization of the ETL based on the relationship of mapping in FIG. 5B.

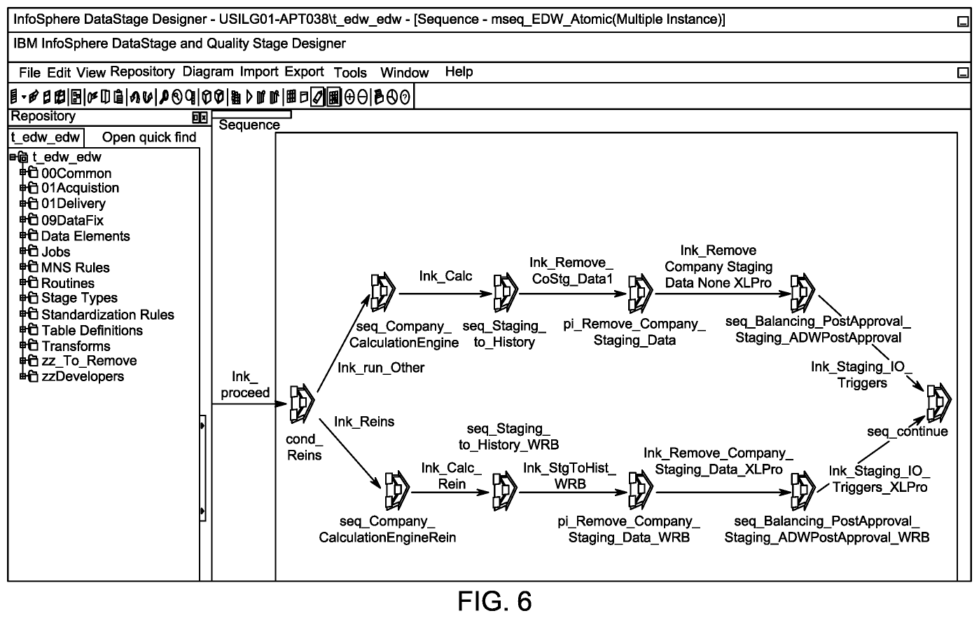

The DAA is configured to automatically generate the extract, transform, load data (ETL) in each metadata component to present distinct values within that component. The DAA then generates ETL to populate the data model. The DAA can also be a part of the data receiver module or the receiver module. FIG. 6 illustrates an exemplary interface for using the DAA. As shown in FIG. 6, multiple steps are indicated, that can analyze incoming data from clients or tenants. Multiple calculation processes, staging processes, and other data analysis steps can be carried out.

The term “ink” or “Lnk” is used in FIG. 6 to represent a link between various processes or tasks. In one exemplary aspect shown in FIG. 6, the DAA is illustrating the sequencing which happens upon approval of the data. The MAT contains the conformed metadata which is used in the first step after “lnk_proceed” in FIG. 6. Based on that metadata, certain paths can be followed. As shown in FIG. 6, in one path, “Lnk_run_Other” will begin the execution of calculations required for gross financial transactions and other KPIs. On another path, “lnk_Reins” (which is shortened for reinsurance) will begin the execution of calculations required for ceded financial transactions and other KPIs. As an example, both instances or paths are directed to revenue recognition. In the remaining sequences, data is archived to prohibit duplicate processing. The final step is committing the data to the warehouse and various marts and for consumption to various reporting tools e.g. OBIEE, and the generation of data for downstream processes.

The DQA+R is configured to automatically evaluate that the data meets business quality rules defined by the business users and remediates known data quality issues. The DQA+R replaces otherwise manual data intervention. The DQA+R is also referred to as a data quality module or a quality module herein.

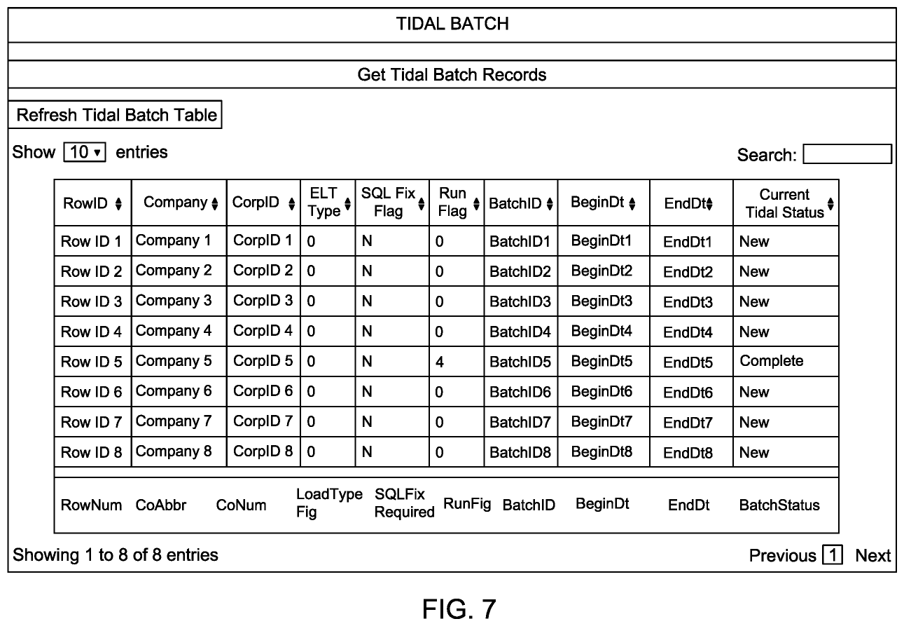

The WE is a fully customized user interface that is configured to allow users to validate data and initiate downstream processing. The WE also supports the generation of journal entries in the general ledger, which facilitates ownership of the data exclusive of technology resources. The WE can be part of the data quality module. One embodiment of a Tidal batch is illustrated in FIG. 7. As shown in FIG. 7, a user can view various information regarding a particular batch of records, such as the company information, ELT type, dates, and status.

The EDS is configured to create customized jobs using trigger points from the data governance dashboard, as well as other key data and reference data dependencies to dynamically inject a consistent code base into the data flow. Using metadata defined within the MAT, the DAA is configured to determine which jobs should be written to the scheduled EDS. This arrangement is configured to allow for one source system/operating unit to have at least two processes, such as creating journal entries and processing to XLPro while another unit could have three processes, such as creating entries, creating reserving models and extracting data. This is shown, in one aspect, by FIG. 7 with each process having a Row ID.

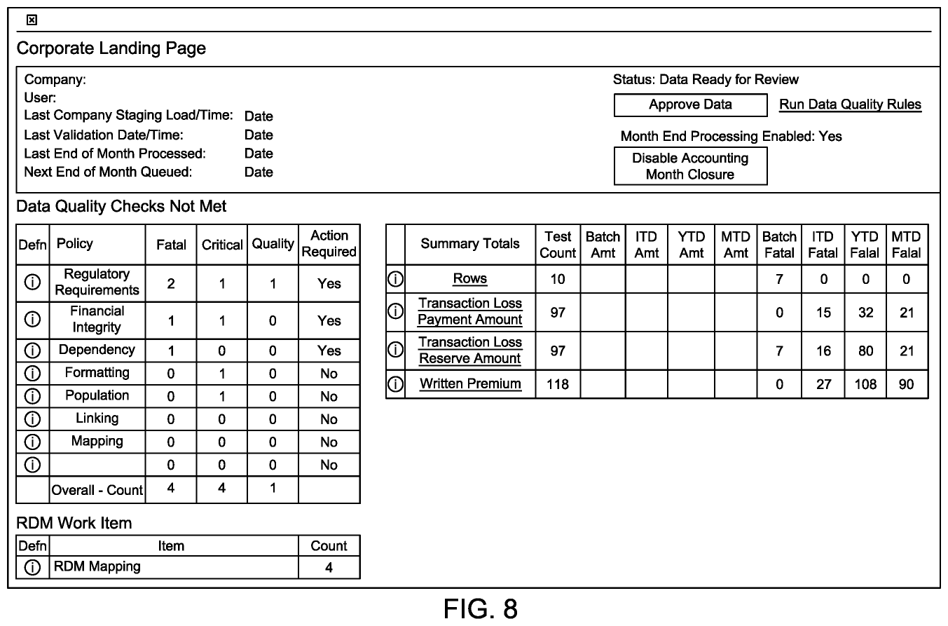

The EDS is also referred to as an event driven scheduling module herein. One embodiment of the data governance dashboard is illustrated in FIG. 8. As shown in FIG. 8, a user can review whether data quality checks have been met based on various policies. FIG. 8 illustrates one example of how a user can quickly analyze and determine whether data quality checks were met or not met. As shown in the upper right-hand side of FIG. 8, a user can then interact with the system to either approve the data or disable accounting closure procedures. The user can also quickly access and run data quality rules. As illustrated in FIG. 8, the user can quickly surmise any issues with the data load, such as data quality issues, balancing issues in the load and missing mappings and any other number of pre-defined rules. Drill through capabilities can be provided to the data steward, i.e. user, to allow them to view the granular level of data to take corrective actions. This dashboard also holds an exception-based workflow which allows the data steward to quickly assess the data quality.

The RDD is configured to use metadata to generate an experience-based engine that identifies new reference data from the warehouse and automatically triggers loading of new reference data and notification to data stewards. The RDD is also referred to as a reference data discovery module herein.

The RDMSE is configured to provide automatic mapping based on experience-based decision making which is combined with artificial intelligence. The RDMSE is also referred to as the reference data mapping suggestion module herein. In one aspect, the RDMSE provides automatic mapping by considering prior mappings for similar data elements as well as using artificial intelligence (AI) methods such as natural language processing (NLP) in new situations.

The CE is configured to implement a logic system or algorithm to leverage metadata and reference data mapped by the user or business to parameterize various data enrichment calculations related to industry-specific accounting guidance (e.g. accruals, revenue recognition). The CE analyzes all dimensions of the base data or information. In one embodiment, the CE is configured to receive inputs and uses metadata and reference data to determine more complicated aspects of the insurance data, such as premiums, foreign currency calculations, etc. In one embodiment, the CE is referred to as a calculation module.

In one aspect, the CE is used to standardize calculations. In one aspect, the CE is configured to intake information, such as premium and commission transactional details, and earns each out based on an assigned earning method for a specific policy. Earnings can be calculated based on an assigned method and accounting dates for a transaction effective date, transaction expiration date, and book date. In one aspect, there can be at least three calculation methods or protocols used by the CE: daily pro-rata, daily earning with factors, and fully earned.

Daily pro-rata is configured to analyze a premium that is earned in equal daily installments over the life of the transaction. In one aspect, the transaction life is based on the number of days between the effective data and expiration date. The daily earning rate can be calculated based on the total of the written premium divided by the transaction life. A monthly earned premium can be based on the number of earning days in a month multiplied by the daily earning rate. Exemplary tables are shown below illustrating aspects of the daily pro-rata method. As shown in this example, the transaction life is ‘2016-08-12’ to ‘2017-02-11’ or 184 Days, and the premium daily earning rate is 5,520.00/184 or 30.00 per day. Attribute Source System Value

| Attribute | Source System Value |
|---|---|
| Written Premium | 5,520.00 |
| Transaction Effective Date | 2016 Aug. 12 |
| Transaction Expiration Date | 2017 Feb. 11 |
| Book Date | 2016 Oct. 31 |
| Calculation Method | PRO-RATA |

| | Earning | Daily | Earned |
|---|---|---|---|
| Accounting Date | Days | Rate | Premium |
| 2016 Oct. 31 | 81 | 30 | 2,430 |
| 2016 Nov. 30 | 30 | 30 | 900 |
| 2016 Dec. 31 | 31 | 30 | 930 |
| 2017 Jan. 31 | 31 | 30 | 930 |
| 2017 Feb. 28 | 11 | 30 | 330 |
| TOTAL | | | 5,520.00 |

The daily earning with factors method analyzes the premium that is earned in variable daily installments over the life of the transaction. In one aspect, the transaction life is divided into slices in which each slice is a percentage of the earning amount and a percentage of the earning period. The earning amount and period percentages have a total sum of 1000% for a given transaction. Factors can be parametrized to align a specific exposure that is appropriate for a given policy term. In one example, a three year contract that earns 600%, 20%0, and 20% in the 1st, 2nd, and 3rd year respectively would be represented as described in the Table below.

| | Earning | Earning | |
|---|---|---|---|
| Slice | Amount % | Period % | Comments |
| 1 | 0.6 | 0.333 | First slice will earn 60% of the |
| | | | amount over 33.3% of the time |
| 2 | 0.2 | 0.333 | Second slice will earn 20% of |
| | | | the amount over 33.3% of the |
| | | | time |
| 3 | 0.2 | 0.334 | Third slice will earn 20% of the |
| | | | amount over 33.4% of the time |

The fully earned method analyzes the premium that is fully earned at the time of the transaction. The fully earned method records the entire premium in a single account month as the book date. This method is configured to carry out calculations regardless of the earning method attached to a specific premium transaction, and is dependent upon transaction dates, book dates (such as audit premiums), etc. In one aspect, premium transactions are identified or marked as fully earned. In another aspect, a premium is fully earned in this method when the book date is greater or equal to a transaction expiration date.

Two examples are provided below using the fully earned method. In Example 1, there are certain premium transactions that are marked as fully earned. In Example 2, the premium can be fully earned when the book date is greater or equal to the transaction expiration date.

### Example 1

| Attribute | Source System Value |
|---|---|
| Written Premium | 500.00 |
| Transaction Effective Date | 2016 Aug. 12 |
| Transaction Expiration Date | 2017 Feb. 11 |
| Book Date | 2016 Oct. 31 |
| Calculation Method | FULLY EARNED |

| Accounting | Earned | |
|---|---|---|
| Date | Premium | Comments |
| 2016 Oct. 31 | 500.00 | Premium is fully earned because |
| | | of the “Earning Method” chosen |
| 2016 Nov. 30 | | |
| 2016 Dec. 31 | | |
| 2017 Jan. 31 | | |
| 2017 Feb. 28 | | |

### Example 2

| Attribute | Source System Value |
|---|---|
| Written Premium | 500.00 |
| Transaction Effective Date | 2016 Aug. 12 |
| Transaction Expiration Date | 2017 Sep. 30 |
| Book Date | 2016 Oct. 31 |
| Calculation Method | PRO-RATA |

| Accounting | Earned | |
|---|---|---|
| Date | Premium | Comments |
| 2016 Aug. 31 | | |
| 2016 Sep. 30 | | |
| 2016 Oct. 31 | 500.00 | Premium is fully earned because |
| | | the ‘Book Date’ is after the |
| | | “Transaction Expiration Date’ |

The RE is configured as a customized interface configured to interact with XLPro that uses reference data management to create consistency and ease of use for both contract entry (e.g. robotic process automation) and calculation of outwards reinsurance. The interface is configured to define the reinsurance contract and ceding criteria based off the common code values defined in reference data management. The RE is configured to review data and address issues that arise from a ceded reinsurance basis. The RE operates under a similar set of logical principles and algorithms as the CE, but is configured to analyze and manage enriched data that is output from the CE. In the insurance industry, it is critical to have both sets of data analysis in order to have a full and accurate picture of the risk of a particular insurance contract or asset. The combination of the CE and RE provides the true risk of a particular contract because this combination of analysis provides both the gross data and the ceded data to provide the net data. The RE is also identified as a reinsurance module herein.

The system and method disclosed herein are configured to analyze the changing risk value of a particular insurance policy. For example, the insurance policy associated with an oil drilling insurance contract is very high at the initialization of the project, and gradually decreases over time. The CE and RE make it possible to analyze metadata associated with this type of insurance policy to recognize earning up front. The CE is configured to identify when insurance risks are greatest to improve earnings. The CE is configured to allow the client, user, or business the granularity to assess the risk to the organization at an earlier point in the underwriting process.

The JEA is configured to provide consumption, implementation, and remediation of general ledger edits to automate the interface to the general ledger system allowing for a single comprehensive entry which can then be approved within the ledger application without intervention. In one embodiment, the JEA is referred to as a journal entry module.

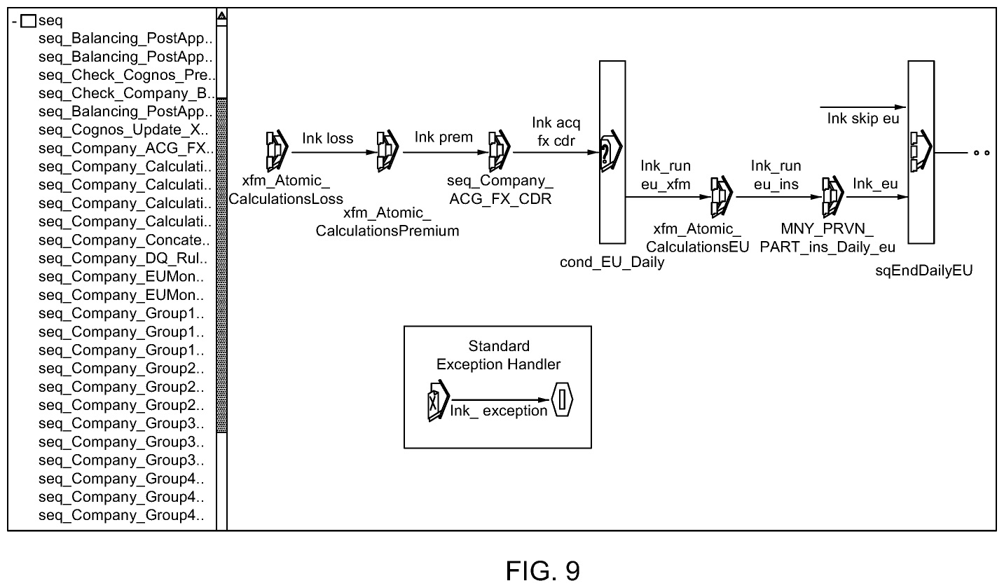

The Configuration Engine is configured to utilize metadata to perform automated application configurations across multiple components of the solution. The Configuration Engine is also referred to as a configuration module herein. The Configuration Engine is illustrated in FIG. 9. In FIG. 9, the first four steps or processes represent common core foreign currency exchange processes utilizing the MAT “cond_EU_daily” generates exception-based processing. In one example, a common core currency calculation is based on historic rates with the EU exception to use daily transactional rates.

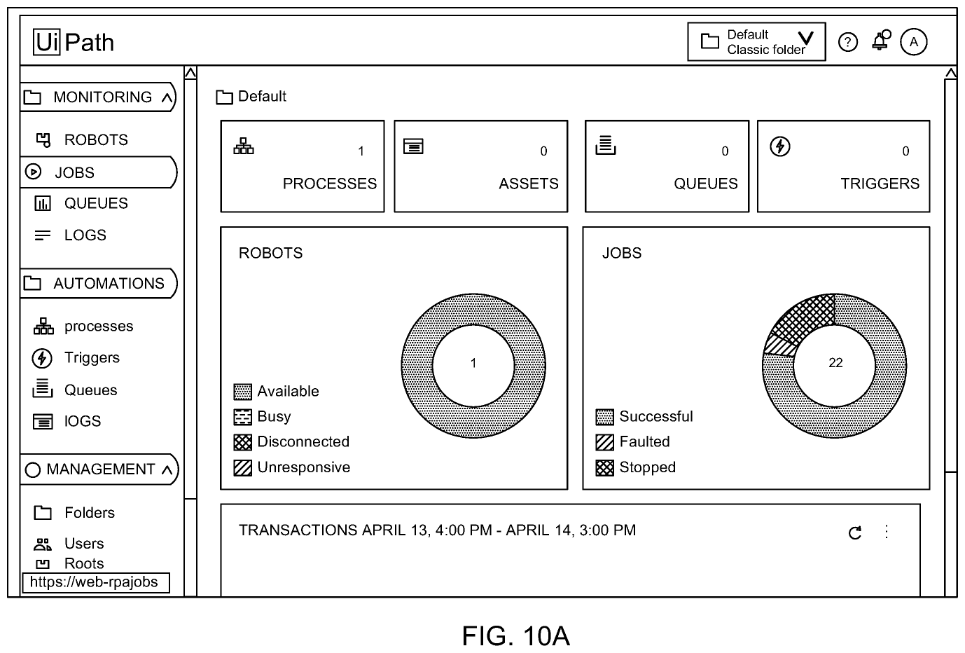

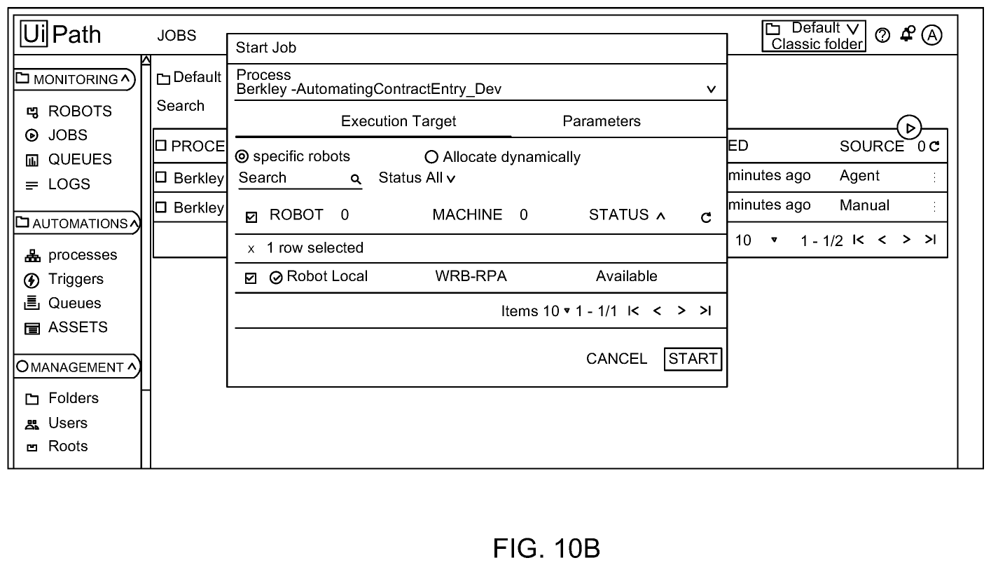

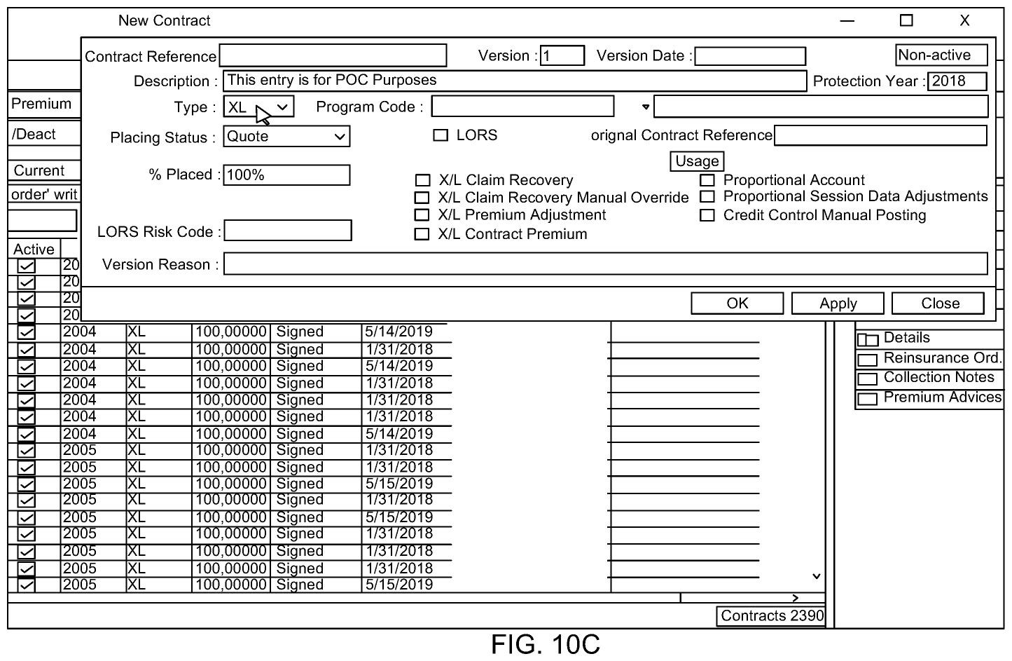

The Data Entry Automation module is configured to perform automated entry into various applications to ensure appropriate configuration and integration. FIGS. 10A and 10B illustrate different aspects of the Data Entry Automation module. FIG. 10C illustrates one embodiment of an RPA data entry interface. In one aspect, various tasks, such as contact entry can be automated by the Data Entry Automation interface. As shown in FIGS. 10A-10C, multiple robots are defined to execute defined “jobs” in order to set up reinsurance contract in XLPro to minimize manual intervention. RPA also provides a dashboard configured to present the output or results of the jobs executed by the robots and their success or failure.

The FET is configured to utilize transaction effective dates obtained from the system in conjunction with foreign exchange rates, and is configured to generate at least four different currency conversions with varying accounting treatments. These calculations utilize the transactional amounts and currencies and apply the specific treatment to generate legal entity-specific domicile, reporting, local, and USD equivalents.

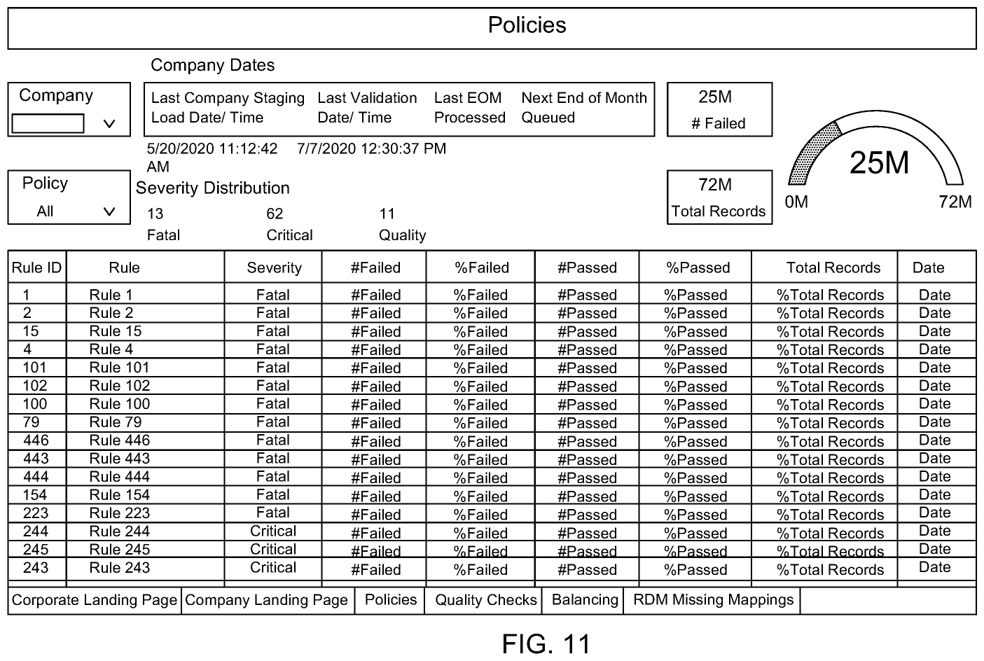

The DA is configured to provide customized reports using reference data management hierarchies and values which facilitate a directed analysis based of decision trees which allow to start high-level indicators and focus on the root cause. This allows for exception-based workflow. The DA is also referred to as a directed analytics module herein. The data governance dashboard is illustrated according to one embodiment in FIG. 11. As shown in FIG. 11, a user can quickly analyze specific policies and identify any errors in the data that has been collected. The severity (e.g., fatal, critical, etc.) of each of these errors is characterized by the DA. In one aspect, the determination of the severity is pre-defined by the appropriate functional owner of the rule e.g. accounting, claims or enterprise risk management. Certain data attributes have a higher significance to differing functional departments. A graph is generated to indicated the total number of failed records. As used in this context, the term records can refer to the number of rows submitted into the database which was profiled by the DA.

The MDRLS is configured to utilize reference data management values and hierarchies to assign security to one or many dimensions for one or many users to control permission regarding viewing the data. The MDRLS is also referred to as a multi-dimensional security module herein.

In one embodiment, the MAT, DAA, DOA+R, RE, and DA are customized systems, modules, or interfaces originating from third party service providers.

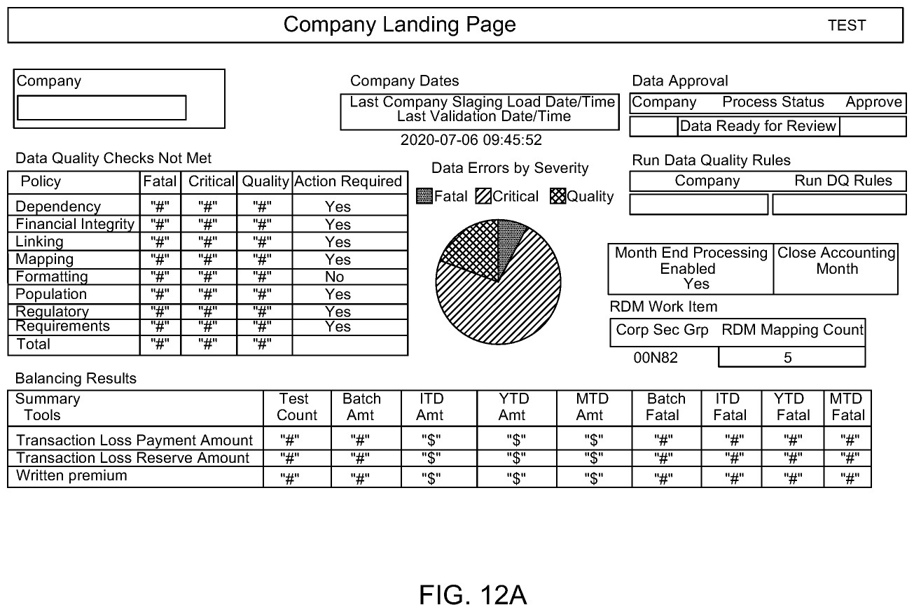

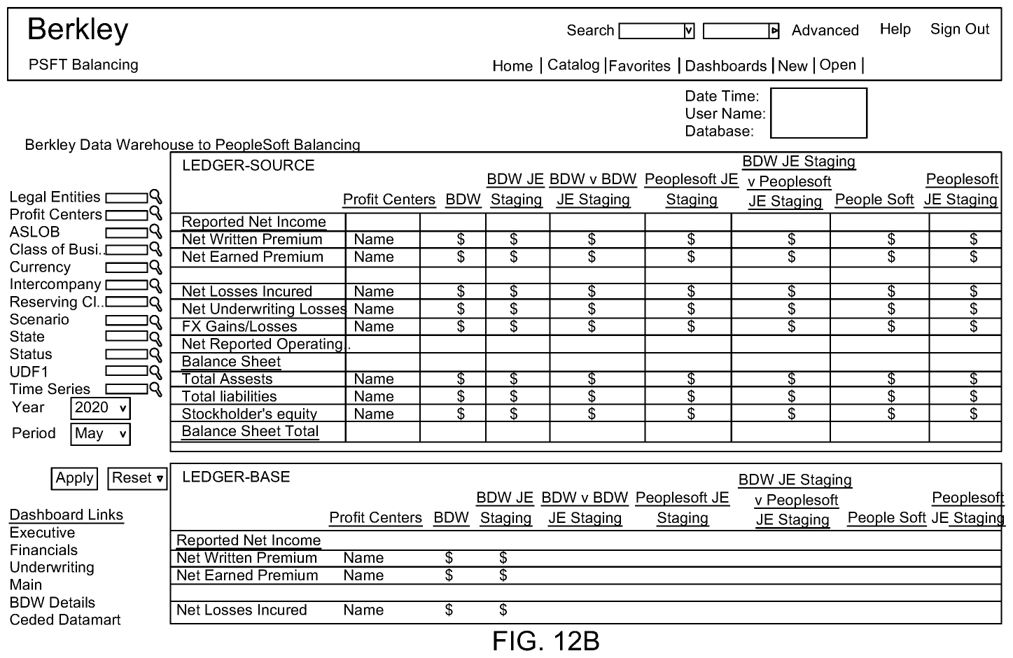

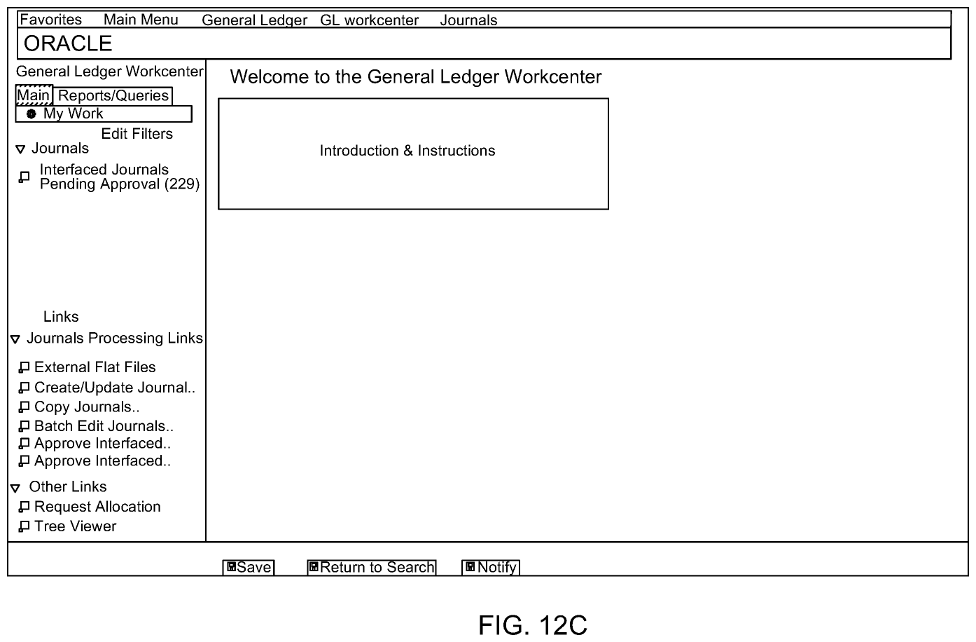

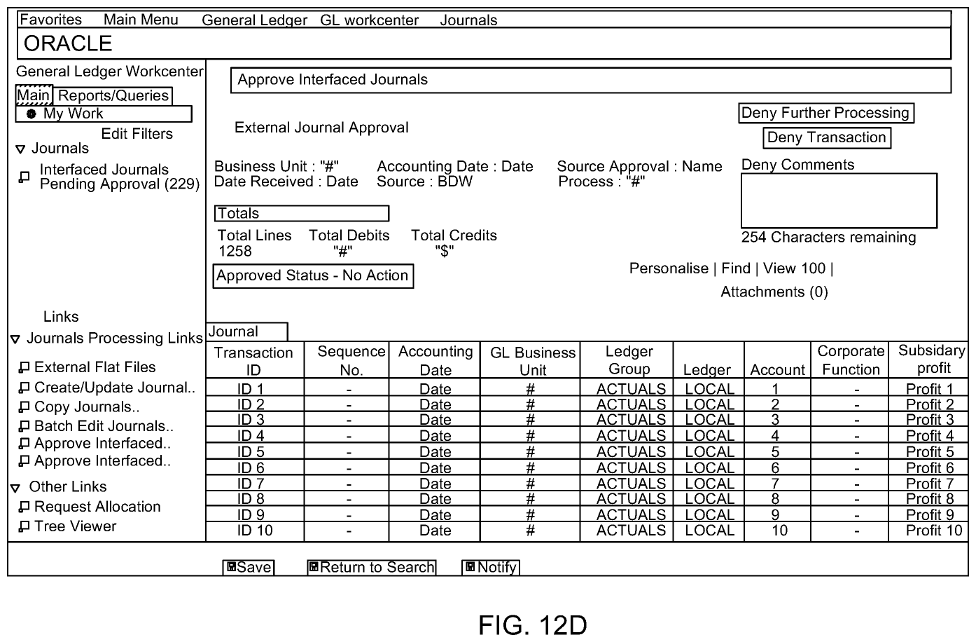

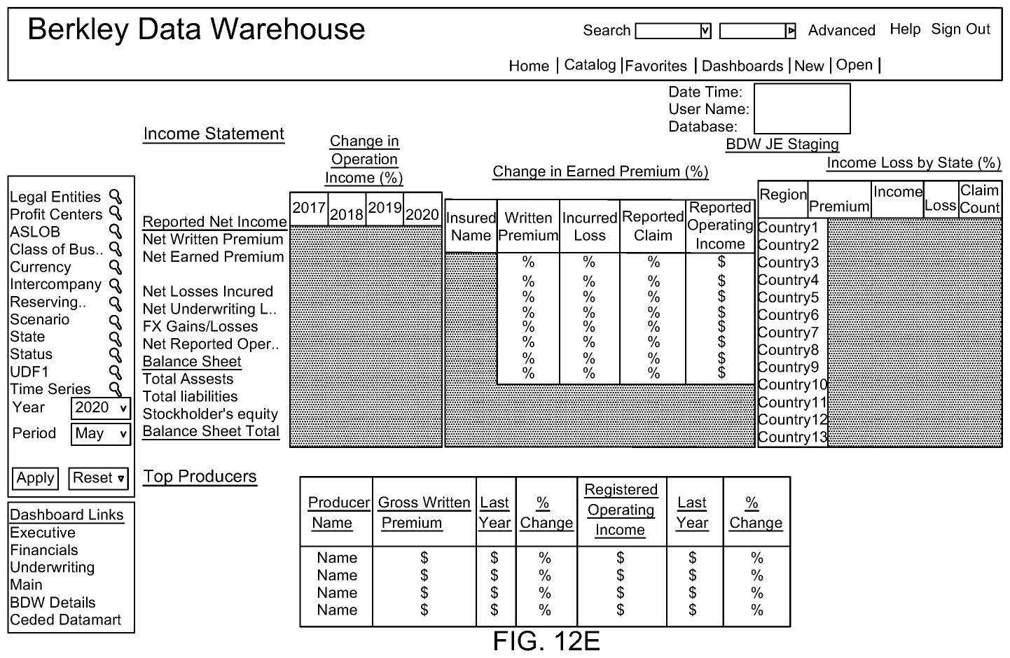

FIG. 12A illustrates one embodiment for a company landing page interface. As shown in FIG. 12A, a user can quickly review company data, data errors, balancing results, data quality checks, etc. As shown in FIG. 12A, a user can quickly determine if action is required with respect to any policies, such as dependency, financial integrity, linking, mapping, formatting, regulatory requirements, etc. There are varying actions that can be taken depending on the policy or rule violated. For example, if there is a linking error, then the data remediation tool will automatically check if there is a pre-defined remediation and update the record accordingly. In the event that the remediation tool does not find any value, a manual intervention will take place from a user, such as technical support. In another scenario, if a mapping is missing then the user can view the exception and then update the mapping value and re-run the data quality rules to ensure it has been corrected. If everything is determined to be complete and accurate, then the user can approve the data for downstream processing.

FIG. 12B illustrates one embodiment for balancing in OBIEE/PeopleSoft. As shown in FIG. 12B, a user can quickly determine the net written premium, net earned premium, net losses incurred, net underwriting losses, FX gains/losses, net reported operating income. A user can also quickly review the total assets and liabilities, stockholder's equity, and balance sheet totals. FIG. 12C illustrates a landing page for PeopleSoft in which customized key items include “Interfaced Journals Pending Approval” and “Approve Interfaced Journals.”

FIG. 12D illustrates one embodiment of an approval interface in which a user can accept or deny a journal. Multiple business units in a single journal can be provided, including multiple accounts. If a journal is rejected or denied, then data can be rectified and reprocessed. In the event that it is determined that a journal entry does not balance or chart fields are not present, then the journal entry can be denied by a user, such as personnel on a corporate finance team. Remediation of the issue can be accomplished by adding the chart field to PSFT (Peoplesoft) if deemed appropriate or by updating the data in the data warehouse, if necessary. The journal entry will then be reprocessed and subsequently approved. FIG. 12E illustrates one embodiment for the OBIEE dashboard.

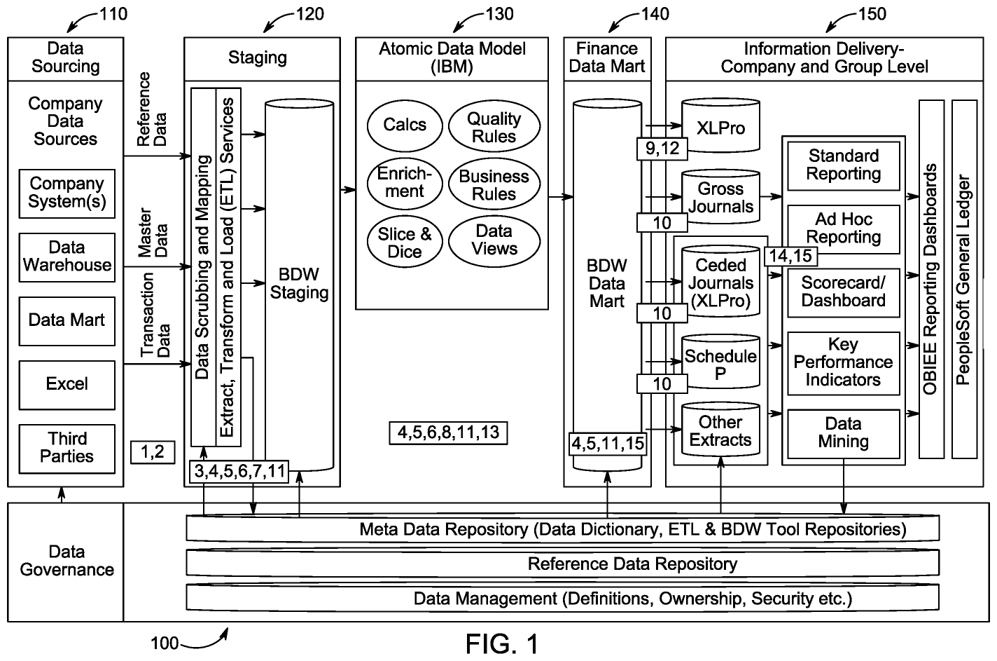

FIG. 1 illustrates a data system 100 including the components described above. Between various steps in FIG. 1, boxes include various reference numerals indicating the components or modules that are used during a particular step. In FIG. 1, the MAT is element 1, the DAA is element 2, the DQA+R is element 3, the WE is element 4, the EDS is element 5, the RDD is element 6, the RDMSE is element 7, the CE is element 8, the RE is element 9, the JEA is element 10, the Configuration Engine is element 11, the Data Entry Automation module is element 12, the FET is element 13, the DA is element 14, and the MDRLS is element 15. Certain elements are used during more than one step, as shown in FIG. 1.

Although certain steps identify specific elements as being used, one of ordinary skill in the art would understand that more or fewer components can be used for each step. Additionally, each of the components or modules are in communication with each other.

Arrows extending between any components are generally used to indicate workflow or transmission of information and data. One of ordinary skill in the art would understand that the workflow could also go in the opposite direction of any arrows that are illustrated.

As shown in FIG. 1, data is sourced directly from operational systems or applications at step 110. Data sourcing can include various different types and files relating to a company's data, such as company systems, data warehouses, data marts, spreadsheets (e.g. Excel files) and other third-party origins. One of ordinary skill in the art would understand that other origins of data sourcing may be available. As shown below step 110, a data governance module is also included.

From the data sourcing step 110, various types of data, including reference data, master data, and transaction data is then moved onto the staging step 120. The MAT 1 and DAA 2 are used to facilitate transferring data between steps 110 and 120. The MAT 1 allows a user to pull data and information from many sources and move these elements into respective categories during data sourcing. The DAA 2 then processes this data and information.

During staging 120, incoming data and information is scrubbed and mapped. Additionally, ETL services are also performed on the data sets. Step 120 includes at least the DQA+R 3, the WE 4, the EDS 5, the RDD 6, the RDMSE 7, and the Configuration Engine 11. One of ordinary skill in the art would understand that additional or fewer components can be used during this step.

During step 120, data is exchanged between the modules and a metadata repository. In one embodiment, the metadata repository includes resources such as data dictionaries, ETL tool repositories, and other company repositories. The data is also exchanged with a reference data repository. Data management modules are also provided, which define specific terms, ownership aspects, security elements, and other insurance related provisions. These repositories can be accessed or queried at any step of the system. As shown in step 120, staging, i.e. BDW staging, is performed during this step. This step includes running the data quality rules, executing the balancing to ensure completeness of data for subsequent steps. In the staging area, the source data is received. After sourcing the data, the mapping to corporate standards can take place and is executed. As used in this context, the term BDW refers to the Berkley Data Warehouse.

A data modeling step 130 is illustrated next in FIG. 1. In one aspect, the data modeling step 130 is an atomic data modeling step. Data enrichment and calculation activities are carried out during step 130. For example, calculations regarding earnings, losses, commissions, and other insurance related variables are performed. Step 130 includes at least the WE 4, the EDS 5, the RDD 6, the CE 8, the Configuration Engine 11, and the FET 13. One of ordinary skill in the art would understand that additional or fewer components can be used during this step. Various data functions can be implemented during this step, including calculations, enrichment, slicing and dicing (e.g. multi-dimensional data analysis), quality and/or business rule analysis, and implementation of various data views.

Step 140 is identified as the finance data mart in FIG. 1. Data is processed from the data model in step 130 and then further processed via the finance data mart in step 140 for reporting. Step 140 generally includes the BDW Data Mart, in one aspect, which refers to the Berkley Data Warehouse Data Mart. An output application, such as PeopleSoft, receives a feed for the general ledger after step 140. In one embodiment, steps 130 and 140 are combined into a single step. Step 140 includes at least the WE 4, the EDS 5, the Configuration Engine 11, and the MDRLS 15. One of ordinary skill in the art would understand that additional or fewer components can be used during this step. As shown in FIG. 1, the finance data mart is in communication with the metadata repository, reference data repository, and data management module.

Step 150 generally includes the delivery of information to a user to client, which can be at the company or group level. In order to provide information for the next step 150, the finance data mart 140 uses the RE 9 and the Data Entry Automation module 12 to output data to XLPro. The JEA 10 carries out multiple functions between steps 140 and 150. The JEA 10 is configured to output gross journals between steps 140 and 150. The JEA 10 is also configured to output ceded journals (for example in XLPro) between steps 140 and 150. Finally, the JEA 10 is also configured to output Schedule P and other extracts between steps 140 and 150.

Information from the gross journals, ceded journals, Schedule P, and other extracts is then further processed during step 150 to generate any one or more of the following: standard reporting, ad hoc reporting, an overview scorecard/dashboard, key performance indicators, and data mining. These further processing steps can be carried out by the DA 14 and the MDRLS 15.

The final portion of step 150 includes providing business intelligence reporting dashboards and the general ledger. Step 150 can further include providing interfaces for users to interact with. For example, a user can engage with buttons in the dashboard or interface to either approve or deny certain figures, transactions, or other financials. One advantage of this step is that there is consolidated data to reduce redundancy and increase data quality for various report needs in a common set of definitions. Once the journal entry is approved, the accounts are updated with the financial information which was previously approved and reviewed by a user, such as personnel from a finance team. As an example, the journal entry is supported by validation reports or audit trails evidencing the completeness of the underlying data as it moved through the process from source to the general ledger. In FIG. 1, these aspects are identified as OBIEE and PeopleSoft, but one of ordinary skill in the art would understand that other programs and/or services can be used.

The steps in FIG. 1 can generally be summarized as data gathering at step 110, data staging at step 120, data analysis at step 130, post-analysis staging and processing at step 140, and reporting at step 150. Based on the reporting at step 150, the user then can take further action, such as approving, rejecting, or requesting further information regarding specific data or reports. Step 110 generally includes data extraction from various, different sources. Step 120 generally includes harmonizing the raw data from step 110 and mapping the data to a common set of terms. As used in this context, raw data can mean data extracted from the source system prior to any transformations. Multiple tenants typically have raw data in different formats.

Step 130 generally includes analyzing the harmonized data from step 120 in order to validate the harmonized data and check for deviations. Step 130 allows a user to identify any issues and obtain more information on these issues prior to approval. Step 140 is automatically triggered after step 130 and allows for further analysis of the information prior to posting and creating journal entries. Step 150 generally includes posting of the journal entries. The system 100 also includes a ceding process in which gross data after step 140 is processed to calculate outwards reinsurance data.

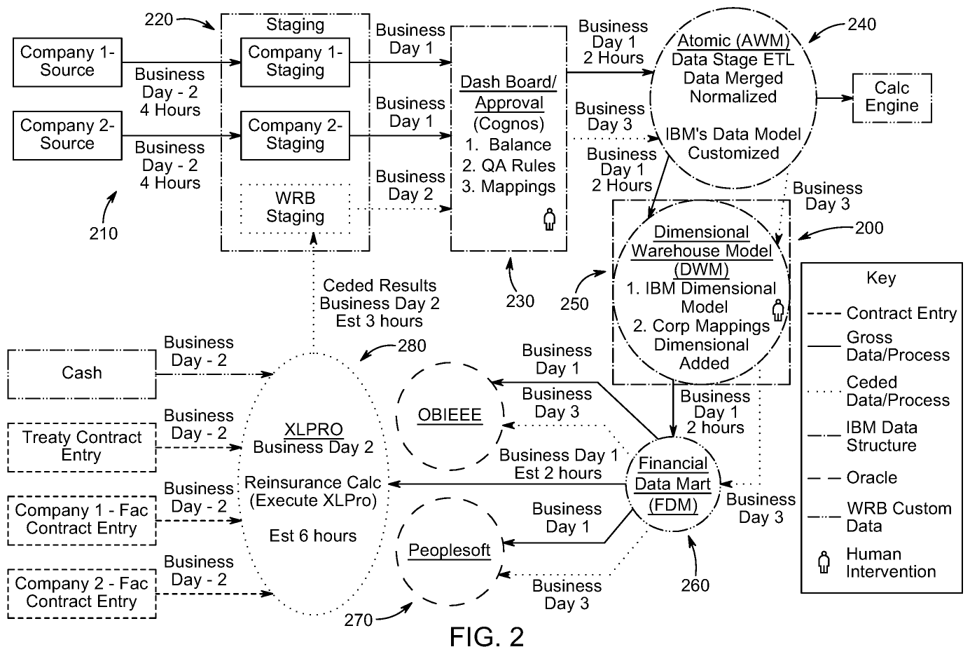

FIG. 2 illustrates a business process flow diagram 200 showing how the processes described above in FIG. 1 are implemented between customers or end users (i.e. commercial insurance tenants) and the general ledger. By pulling the data into consistently defined columns and by mapping the data into consistently defined values, the systems and methods disclosed herein address technological problems associated with integrating and collecting data from multiple points, i.e. tenants, clients, etc., that use disparate reporting systems. As an example, a company may use multiple fields to determine their annual statement line (ASLOB). The system is configured to take in a concatenation of these fields into the ASLOB column in staging and then apply their business rules via mapping to get to the conformed value of the ASLOB. In other words, the present disclosure synchronizes data from multiple disparate sources to avoid the technological issue of misinterpreting or otherwise not correctly processing data.

A Key is provided in FIG. 2 for multiple elements. Per the Key, contract entries are indicated by medium dashes, as generally shown in the lower left corner of FIG. 2. Gross Data/Processes are indicated by completely solid lines, such as the Company 1—Source and Company 2—Source in the upper left corner of FIG. 2. The ceded data/process is indicated in FIG. 2 by small dotted lines, such as the circular XLPro element in the lower left portion of FIG. 2. The IBM data structure is indicated in FIG. 2 by a medium dash and a dot pattern, which is shown by the Atomic Warehouse Model (AWM) circular element and the Dimensional Warehouse Model (DWM) circular element. Long dashes indicate Oracle elements, such as OBIEE and PeopleSoft. WRB Custom Data is indicated by a single medium dash and two dots, such as the Financial Data Mart (FDM) next to the Key. A human intervention icon is also shown in the Key to illustrate steps which may require user intervention, such as steps 230 or 250 in FIG. 2. While this Key indicates certain elements or aspects are carried out, implemented, or processed by a particular component, one of ordinary skill in the art would understand that the specific components carrying out any of these elements can vary.

Throughout FIG. 2, there are various time limitations indicated, such as “Business Day” and a specific numeral value regarding the day or hours. These time indications are provided for exemplary purposes only and to provide an indication of how the workflow may be carried out over time. One of ordinary skill in the art would understand that the exact workflow can vary. Certain time indicators refer to a negative value, i.e. Business Day—2, which is used to indicate actions that occur prior to a reference point of the initial Business Day.

As shown in FIG. 2, at step 210 there are two company sources that provide data to the staging process. One of ordinary skill in the art would understand based on this disclosure that the process and system can be implemented for an indeterminate amount of end users. Data extractions occur from multiple source systems in order to implement the month-end closing process. In order to carry out this step, personnel, such as IT, execute data acquisition and data sourcing from multiple end users. The MAT 1 and the DAA 2 are primarily used during this process. The MAT 1 and the DAA 2 support the source (i.e. the end user or customer) for a target mapping process by using metadata to automate data acquisition.

In the lower left-hand side of FIG. 2, various data and information is input to XLPro. This information can include data regarding cash, treaty contract entries, or a company's facultative (shortened to “Fac” in the drawings) reinsurance contract entries.

During the staging step 220, data is processed via an ETL process to harmonize the data intake and provide the data in a uniform and user-friendly/consumable manner for further processing. IT personnel can execute the transfer of data from the source to the staging phase. In one aspect, stored ETL procedures are scheduled to pull data from production source systems into the staging databases. In one aspect, a staging area is an intermediate storage area used for data processing during the extract, transform and load (ETL) process. The staging area is implemented in the form of tables in relational databases, in one aspect. The system is configured to process multiple different timings for closings across multiple companies. The incoming data is checked against pre-defined data business rules following the data governance process. Step 220 can include at least the DQA+R 3, the WE 4, the EDS 5, the RDD 6, the RDMSE 7, and the Configuration Engine 11.

Step 230 includes the data governance dashboard approval process. In one aspect, this step uses Cognos business intelligence software. One of ordinary skill in the art would understand that other programs or software may be used. This step 230 similarly is carried out by at least the DQA+R 3, the WE 4, the EDS 5, the RDD 6, the RDMSE 7, and the Configuration Engine 11. During step 230, the user can validate data with data governance tools. In one aspect, step 230 involves checking data according to at least three factors: balance information, QA rules, and mappings. A user can approve the data provided that there are: (i) no outstanding mappings to be performed, (ii) no fatal data quality errors are triggered, and (iii) no balancing issues are identified in the control totals. The user can control whether to accept or decline deviations from target mappings and outcomes. In cases where one of the three items is not satisfied, then the user can still accept the results but it will require a secondary approval in order to override the results. The user can control whether to accept or decline deviations from target mappings and outcomes. During this process, financial dashboards are provided that allow the user to drill-down into specific data sets for further analysis and to check for potential errors in the source data or source systems. As shown in FIG. 11, there are tabs at the bottom which provide details, e.g. list all mapping violations including rule description and severity. For example, the user can access supplemental information or drill-down into information to determine if there are violations against data quality rules based on pre-defined frameworks. Once the user is satisfied with the integrity of the information and data as shown on the dashboard, the user can provide approval, which triggers step 240.

Steps 240 and 250 include automatic post approval processing into atomic and the dimensional data warehouse. Steps 240 and 250 at least include the WE 4, the EDS 5, the RDD 6, the Calculation Engine 8, the Configuration Engine 11, and the FET 13. In one embodiment, these steps are carried out by IT personnel. In one aspect, there may be additional mappings required at this step for new combination of items that may be required to ensure compliance for downstream systems. The process is automatically triggered once the dashboard in step 230 has been approved. During steps 240 and 250, data from step 230 undergoes multiple financial calculations, such as accruals based on the acquired source or reference data. Foreign exchange translations can also be determined during this step.

During step 240, financial calculations are performed in the atomic warehouse model and data is assigned and committed to the appropriate object. For example, a party object represents the type of people who interacts with a transaction. For example, the various individuals associated with the insurance transaction are parties to the transaction and all parties of insurance transactions are captured in a “party object” within the Atomic Warehouse model.

During step 250, information is processed according to a dimensional warehouse model (DWM). This step can include using an IBM Dimensional Model and adding corporate dimensional mappings. The dimensional model takes the objects and translates them into report-friendly structures. For example, the system can be configured to take items from a party object such as insured, producer, claimant and set them up as their own dimension for reporting. One of ordinary skill in the art would understand that other dimensional warehouse tools, software programs, or interfaces could be used.

Step 260 includes automated data distribution via the finance data mart. During this step, a user, such as IT personnel, oversees the monitoring of any exceptions to the automated process. Once the previous steps 240 and 250 have been completed, the data is automatically transmitted to the finance data mart, which then distributes the data to enable and connect with reporting tools, e.g. OBIEE, and create journals in the general ledger. Step 260 includes at least the WE 4, the EDS 5, JEA 10, the Configuration Engine 11, and the MDRLS 15.

After step 260, the process proceeds to posting gross journal entries by business users and business reporting needed to close the gross processing process at step 270. During step 270, monthly journal entries are available to the users for posting to the general ledger. Based on this system, there is a separation of duties and responsibilities between the user approving the dashboard and the user posting the journals. The financial figures are also available for business reporting via OBIEE and other reporting tools, such as Peoplesoft. This step completes the cycle to close the month for gross data. Step 270 includes at least the JEA 10, the DA 14, and the MDRLS 15.

Next, the ceded process is carried out at step 280. During this step, gross data from step 260 is processed to calculate outwards reinsurance financial data and figures. The EDS is configured to trigger the job to load conformed data from the Data Mart into XLPro (RE) where contracts have been entered either through robotic processes or human intervention. Subsequently, the EDS is configured to trigger the jobs required to perform reinsurance recovery and payable calculations. This process is automated to calculate the cash, contract, treaty rules applied to the gross data to provide a ceded data output. This process can be carried out by XLPro. One of ordinary skill in the art would understand that other programs or interfaces can be used for this process. During this process, output is sent back to the staging step 220. The ceded process then undergoes the same steps identified above, such as producing ceded dashboards, ceded journals, ceded reports, etc. Calculations involving the gross data and the ceded data results in the net data, which is then passed through for staging. Steps 220-270 are repeated for the ceded data to provide figures, data sets, journals, reports, etc. Step 280 is carried out by at least the RE 9 and the Data Entry Automation module 12.

The system disclosed herein provides improved control for users or businesses to output data without external intervention, such as from IT. A data governance dashboard can be configured to be interactive and provide the ability to drill down into data sets.

The monthly closing process is expedited based on the present system. Gross and ceded data is automatically processed and the system is configured to allow users to intuitively and quickly access this data. In one aspect, the system provides advantages due to its ability to provide consistent financial reporting in a timely manner, consistent definition of KPIs, and transparency into the translation of data which is defined by the business user. The system also provides a known triage process when errors (i.e. deviations, mistakes, missing data) are encountered, and the ability to ingest additional source systems making upgrades and acquisitions more efficient. Users can also more quickly and intuitively approve or reject data, run data quality rules, disable closure, deny transactions, deny processing, and other functions using the system and methods disclosed herein.

Workflow automation according to the system disclosed herein provides reliable and independently verified data. This ensures proper audit trails due to the segregation of duties among at least two parties. In other words, an audit trail is generated from the input of raw data through the end of the data processing such that a user can check and verify that the data and information is correct. In one aspect, through various end user reports in OBIEE (for example), the user can follow the transformation of data from the source system into the general ledger.

Data quality is generally improved by the system disclosed herein due to harmonization of data across multiple source system due to the data rules and data governance process being embedded within the system. This harmonization is achieved by the application of the data quality rules in the workflow engine (WE), by calculations performed in the calculation engine (CE).

The present system also provides a reduction in data calls due to the harmonization of data across a business or corporation via the integrated data governance, and a central repository with common data definitions.

Regarding mapping, the present system essentially converts or maps data from a source company/user/tenant to a common term, value, element, etc. Company source values are mapped to common values to conform various different data sets across a variety of sources. For example, in one embodiment a company's annual statement line of business (ASLOB) code can be represented in the source system as D&O|0|PRIM|DIRECTYEJEC, which would suggest it is a primary D&O coverage which would have the common annual statement line of business (“ALSOB”) code of 173. Another example might be a source system value for a coverage of AB and description of AL/OVER-ROAD BUSES. This would translate into the conformed corporate value of 011010000334 with description AL-OTR Buses.

Additionally, the system provides a mapping for common values. Common values can be combined and mapped into other corporate values to drive downstream processing. In one embodiment, the common values can be common to General Ledger, ERM, US STAT, AM Best, Solvency II, PNC II, and/or Lloyds. One of ordinary skill in the art would understand based on this disclosure that this list is non-exhaustive and other values could be used.

Specific programs and applications are identified by name throughout this disclosure. One of ordinary skill in the art would understand that these specific programs and applications can be used, or alternative programs and applications can be used to carry out any one or more of the tasks and steps disclosed herein.

The present disclosure is directed to month end or monthly data processing in one aspect, but one of ordinary skill in the art would understand that the system and processes disclosed herein can be adapted to any specific time period or cycle.

One of ordinary skill in the art would understand that the steps disclosed herein can be performed by a single central processing unit (CPU) or by a network of CPUs. The CPU can include a user input device, such as a keyboard and mouse, a display, a memory unit, and a processor. Any of the steps disclosed herein can be carried out by the CPU. Any of the modules disclosed herein can be integrated with the CPU or can be configured to interface with the CPU. Any one or more of the modules disclosed herein can be stored remotely, e.g. in a cloud-based network. Each of the modules disclosed herein can be configured to interface with any one of the other modules.

In FIG. 3A, an exemplary device 300 is illustrated for implementing the data system of FIG. 1 and/or the flow diagram of FIG. 2. The device 300 can be a CPU or any other electronic computing device configured to carry out processing, algorithms, computations, etc. The device 300 can include a processor 302, a memory unit 304, a storage unit 306, and an input/output interface 308. The processor 302, memory unit 304, storage unit 306, and input/output interface 308 can be hardwired together or can be connected through wireless or other non-hardwired means. Alternatively, one or more of the processor 302, memory unit 304, storage unit 306, and input/output interface 308 can be stored at a remote location or in the cloud. It is also understood that the device 300 can include additional components not shown in FIG. 3A. The device 300 can be configured to connect with other devices, such as remote CPUs, networks, etc. Any one or more of the modules described herein can be integrated within the device 300 or in communication with the device 300. The memory unit 304 can be configured to store any one or more of the elements or modules 1-15. Similarly, the processor 302 can be configured to run processes or steps mentioned above with respect to FIGS. 1 and 2.

In some embodiments, the processor 302 includes additional CPUs, as well as graphics processing units. The memory unit 304 can be implemented in a variety of configurations, such as volatile memory, non-volatile memory, and/or random-access memory (RAM). The storage unit 306 can include fixed storage and/or remote or removable storage, such as external hard drives, cloud-based storage, etc. On the input side, the input/output interface 308 can include keyboards, touch screens, audio input devices, video capturing devices, scanners, etc. The output side of the input/output interface 308 can include a display or monitor, any other device for outputting or displaying information. For example, the input/output interface 308 can be configured to display the images shown in any one or more of FIGS. 4-12E. The input/output interface 308 can be configured to display a dashboard. The input/output interface 308 can be manipulated, such as via a keyboard, etc., to drill down, analyze, or otherwise interact with any information displayed on a monitor of the device 300.

As shown in FIG. 3B, a plurality of devices 300a, 300b, 300c, etc., can be connected to the data system 100. The devices 300a, 300b, 300c can be connected to the data system via the internet or other connection. The devices 300a, 300b, 300c provide interfaces for users to the data system 100, in one aspect.

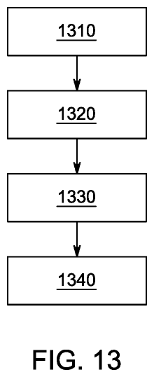

In one aspect, a method is shown in FIG. 13. The method can include step 1310 which comprises collecting raw data from a plurality of users. In one aspect, the raw data can include different file types and different naming conventions. For example, the raw data may include claim data, coverage data, contract data, risk data, term data, loss data, premium data, receivables data, and submissions data. Additional data could be used.

The method also includes step 1320 which comprises staging the raw data by analyzing the raw data based on data quality rules and data governance protocols. As used in this context, the term data quality rules refers to the application of specific checks on attribute and amount data in the staging database to ensure that it is fit for its purpose. An example of a data quality rule would be checking an open and closed date on a claim and verifying that the open date is prior to the closed date. The term data governance protocols refers to remediation of identified data quality rules prior to approving the data to pass further downstream. An example of a remediation may be to correct a value in the source system and repull the data into staging. Another remediation may be to allow the data to flow through, but make appropriate adjusting entries in downstream systems. The remediation process depends on the downstream impacts of the data quality rule failure and any potential delay to the accounting close. In one aspect, step (b) further includes reviewing the raw data based on data governance rules and data quality rules. Reviewing of this information can be performed via a user through the interface.

In one aspect, step 1320 can further include mapping the different file types and different naming conventions to a single common set of file types and naming conventions. In this way, the method can harmonize or synchronize multiple different sets of data with each other. Step 1320 further includes providing a user interface in which a user can validate the raw data, in one aspect.

The method also includes step 1330, which comprises enriching the raw data and calculating a plurality of insurance related parameters based on the raw data. In one aspect, the plurality of insurance related parameters include risk data, earnings data, loss data, and commission data. Additional parameters can be used. The raw data is enriched, for example, by calculating earnings of written premium transactions to produce earned premium transactions, application of existing mappings to produced conformed mappings, or foreign exchange translations.

In one aspect, step 1330 further includes processing the raw data through a reference data discovery module which is configured to identify new reference data and trigger loading of new reference data based on the raw data. In one aspect, the reference data discovery module performs this function by reviewing attribute values in the source system, and comparing that to an existing library of previously identified reference data values. Any values that are not already in the library are added to the reference data library for mapping.

The method incudes step 1340 which comprises generating journal entries based on the plurality of insurance related parameters. The journal entries, as used in this context, can include written premium, change in unearned premium, paid losses, change in case reserves, and/or written commissions, among other items. In one aspect, approval from at least two users is required before step 1340. As used herein, approval can include a user providing explicit approval that the process or method should proceed, such as by clicking a button on the interface. In one aspect, step 1340 can further include generating foreign currency exchange rates. These foreign currency exchange can be generated by transaction effective dates and a standard database of exchange rates containing to and from currencies and effective dates.

During step 1340, the method can also include assigning a security protocol to the information generated during step 1340. As used in this context, the term security protocol can refer to which users of the system can have access to which data. For example, only certain individuals can see data for certain business units.

Step 1340 can also include an approval or review aspect, during which a user can quickly and intuitively approve or reject data, run data quality rules, disable closure, deny transactions, deny processing, and other functions.

The method can further include processing the enriched raw data after step 1330 to calculate ceded data. As used in this aspect, the term ceded data refers to any data required to facilitate the calculations associated with reinsurance purchased.

The method can further include providing a dashboard interface configured to display the raw data, the plurality of insurance related parameters, and the journal entries. The interface can include a screen or user interface that is configured to be navigated via the user. The interface can include any one or more of the interfaces depicted in the Figures.

The method can further include creating an audit trail between steps 1310-1340. The audit trail can be in the form of a report showing the total amounts at each stage of the process to verify that there is no data lost or gained during the process, in one aspect. Any one or more of the steps 1310-1340 can be iteratively performed throughout the method.

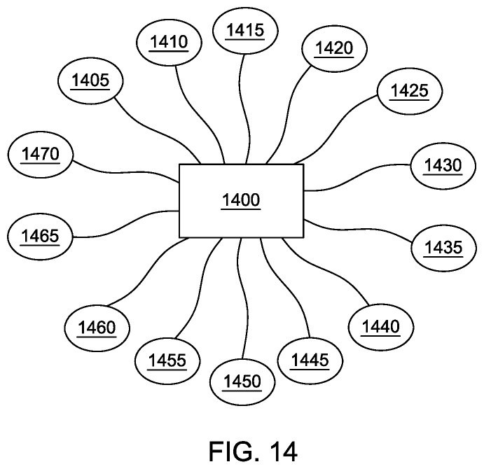

In another aspect shown in FIG. 14, a system 1400 for collecting, organizing, analyzing, and displaying information, and further approving or denying of reports based on the information is disclosed. The system includes a receiver module 1405 configured to receive data input from a plurality of sources. In one aspect, the receiver module 1405 can be in the form of a data storing module that is configured to interface with other components and receive and/or transmit data. A quality module 1410 is also provided that is configured to evaluate data received by the receiver module 1405 and generate staged data. In one aspect, the quality module 1410 includes a processor or other computing element that is configured to analyze the data received by the receiver module 1405 based on a predetermined set of instructions. A visualization module 1415 is configured to display the staged data. The visualization module 1415 can include an output device, screen, or other user interface that is configured to convey or display information to a user. A reference module 1420 is configured to automatically map staged data to a particular mapping element. The reference module 1420 can include a processor or other computing element that is configured to transform or transfer the staged data to a mapping element based on a predetermined setting or protocol. A calculation module 1425 is configured to generate insurance parameters based on the staged data. A journal entry module 1430 is configured to populate a general ledger based at least on the staged data and the insurance parameters.

The system 1400 can further include any one or more of the following elements. A reference data mapping suggestion module 1435 can be provided that is configured to automatically map user data to specific insurance parameters. An event driven scheduling module 1440 can be provided that is configured to create customized reports using trigger points from a data governance module. A reference data discovery module 1445 can be provided that is configured to generate experience-based parameters and to identify new reference data, such that the reference data discovery module 1445 automatically triggers loading new reference data and notifications to a user. A reinsurance module 1450 can be provided that is configured to calculate reinsurance elements. A foreign exchange translation module 1455 can be provided that is configured to generate currency conversions. A multi-dimensional security module 1460 can be provided that is configured to assign security features to information within the system. A directed analytics module 1465 can be provided that is configured to analyze and process data in the system to provide exception-based workflow. The directed analytics module 1465 can include various tools, interfaces, buttons, and user elements that allow a user to approve or deny deports, further analyze reports, access data quality rules, deny further processing, and other functionality. A configuration module 1470 can be provided that is configured to automate application initialization across multiple modules in the system.

Each of the modules included in the system 1400 can function or perform according to the description of the elements, interfaces, and modules described above with respect to FIGS. 1-13.

The methods, systems, flow charts, processes, modules, and other embodiments disclosed herein can be implemented in software, a computer program, and/or hardware. Any one or more of the modules disclosed herein can be implemented in computer-readable storage, such as read only memory (ROM), RAM, and/or other types of computer-readable storage units.

Having thus described the present embodiments in detail, it is to be appreciated and will be apparent to those skilled in the art that many physical changes, only a few of which are exemplified in the detailed description of the embodiments, could be made without altering the inventive concepts and principles embodied therein.

It is also to be appreciated that numerous embodiments incorporating only part of the preferred embodiment are possible which do not alter, with respect to those parts, the inventive concepts and principles embodied therein.

The present embodiments and optional configurations are therefore to be considered in all respects as exemplary and/or illustrative and not restrictive, the scope of the embodiments being indicated by the appended claims rather than by the foregoing description, and all alternate embodiments and changes to this embodiment which come within the meaning and range of equivalency of said claims are therefore to be embraced therein.

What is claimed is:

1. A method of processing and harmonizing raw data to generate reports, the method comprising:
(a) collecting raw data from a plurality of users including a plurality of different file types;
(b) generating extract, transform, load data (ETL) to populate a staging database based on the raw data via analyzing the raw data based on data quality rules and data governance protocols and harmonizing the raw data from the plurality of users;
(c) calculating a plurality of insurance related parameters based on the raw data;
(d) generating a plurality of journal entries and a plurality of insurance key performance indicators based on the plurality of insurance related parameters, wherein the plurality of journal entries includes at least one of: written premiums, changes in unearned premium, paid losses, or written commissions; and
at least one of:
(e) approving at least one journal entry of the plurality of journal entries via a user interface, or
(f) denying at least one journal entry of the plurality of journal entries via a user interface based on detection of an error in the at least one journal entry.

2. The method according to claim 1, wherein the raw data includes information related to at least one of: claim data, coverage data, contract data, risk data, loss data, term data, premium data, receivables data, or submissions data.

3. The method according to claim 1, wherein the plurality of insurance related parameters includes at least one of: risk data, earning data, loss data, or commission data.

4. The method according to claim 1, wherein step (f) further comprises remediating the error either automatically or via manual intervention.

5. The method according to claim 1, wherein step (d) further comprises identifying errors in the raw data based on data quality issues, and alerting a user of the data quality issues.

6. The method according to claim 5, further comprising assigning severity levels to the data quality issues, and assigning predetermined weights based on the severity levels.

7. The method according to claim 1, wherein step (e) requires approval by at least two users if an error is detected in the at least one journal entry.

8. The method according to claim 1, wherein step (c) further comprises enriching the raw data by at least one of: calculating earning of written premium transactions to produce earned premium transactions, applying predefined mappings to the raw data to produce confirmed mappings, or applying foreign currency exchange translations.

9. The method according to claim 1, further comprising providing a plurality of dashboard interfaces configured to display the raw data, the plurality of insurance related parameters, the plurality of insurance key performance indicators, and the plurality of journal entries.

10. The method according to claim 1, wherein approval from at least two users is required prior to step (d).

11. The method according to claim 1, wherein step (b) further comprises checking the raw data against data governance rules and data quality rules.

12. The method according to claim 1, wherein step (b) further comprises mapping the different file types to a single common set of file types.

13. The method according to claim 1, further comprising generating foreign currency exchange rates during step (d) such that all monetary parameters within the raw data from the plurality of users are converted to a predetermined reporting currency.

14. The method according to claim 1, further comprising assigning a security protocol to the information generated during step (d).

15. The method according to claim 1, wherein step (c) further comprises processing the raw data through a reference data discovery module which is configured to identify new reference data and trigger loading of new reference data based on the raw data.

16. The method according to claim 1, further comprising creating an audit trail that at least includes information regarding the identification of a user that approved or denied journal entries, and a timestamp for when journal entries were approved or denied.

17. The method according to claim 1, further comprising calculating earnings of a specific insurance policy during step (d).

18. The method according to claim 17, wherein the earnings are calculated according to at least three earnings calculation protocols.

19. The method according to claim 1, further comprising reviewing attribute values in the raw data, comparing the attribute values in the raw data to a library including previously identified reference data values or attribute values, and adding any new attribute values to the library based on the comparison of the attribute values in the raw data to the library.

20. The method according to claim 1, wherein the plurality of journal entries are supported by audit trails.
